(19) United States
(12) Patent Application Publication
(10) Pub. No.: US 2025/0016722 A1
(43) Pub. Date: Jan. 9, 2025

(54) ANGLE ERROR GROUP FOR DEVICE POSITIONING MEASUREMENT AND REPORTING

(71) Applicant: QUALCOMM Incorporated, San Diego, CA (US)

(72) Inventors: Weimin DUAN, San Diego, CA (US); Alexandros MANOLAKOS, Athens, Attikí (GR); Danlu ZHANG, San Diego, CA (US)

(21) Appl. No.: 18/712,218

(22) PCT Filed: Oct. 28, 2022
(86) PCT No.: PCT/US2022/078906

§ 371 Date: May 21, 2024

(30) Foreign Application Priority Data
Jan. 7, 2022 (GR) 20220100016

(51) Int. Cl. H04W 64/00; H04L 5/00; H04W 24/10

(52) U.S. Cl. CPC H04W 64/00; H04L 5/0051; H04W 24/10

(57) ABSTRACT

Different antenna components of a device cause different biases in calculating a location of a user equipment (UE) based on reference signals from another device (which may be sounding reference signals from the UE or positioning reference signals from a base station). A device is configured to use different subsets of antenna components to calculate a positioning measurement. With each of the antenna components associated with a bias in calculating the positioning measurement, each subset of antenna components is associated with a bias in calculating the positioning measurement. The device is configured to generate and report an angle error group (AEG) report that is associated with the positioning measurements calculated (such as an AEG report including positioning measurements and identifiers indicating the antenna components used). The AEG report is used by a location server to identify the antenna components to be used for UE positioning operations.

### BACKGROUND

### Field

Subject matter disclosed herein relates to wireless positioning of a user equipment and more particularly to the use of angle error groups for selection of which antenna components are to be used for positioning.

### Information

The location of a user equipment (UE), such as a cellular telephone, may be useful or essential to a number of applications including emergency calls, navigation, direction finding, asset tracking and Internet service. The location of a UE may be estimated based on information gathered from various systems. In a cellular network implemented according to 4G (also referred to as Fourth Generation) Long Term Evolution (LTE) radio access or 5G (also referred to as Fifth Generation) “New Radio” (NR), for example, a base station may transmit downlink reference signals or a UE may transmit uplink reference signals that are used for positioning. For example, to perform positioning, a UE may transmit a sounding reference signal (SRS) that is received by a base station. The base station may measure an angle of arrival (AoA) of the SRS to identify a direction of the UE from the base station, may measure a zenith of arrival (ZoA) of the SRS to identify an elevation of the UE with reference to the base station, and may measure a time of arrival (TOA) of the SRS to be used to identify a distance of the UE from the base station. Similarly, a base station may transmit a positioning reference signal (PRS) that is received by a UE, and the UE may measure an AoA, ZoA, and TOA of the PRS to identify a position of the UE with reference to the base station.

### SUMMARY

Different antenna components of a device (such as a base station or a user equipment) cause different biases in calculating a location of a user equipment (UE) based on reference signals from a base station or a UE (such as sounding reference signals (SRSs) transmitted by a UE or positioning reference signals (PRSs) transmitted by a base station). For example, a device (which is either a base station or a UE) to receive a reference signal may include an antenna array with a plurality of antenna subarrays to receive the reference signal (which is either a PRS from the base station or an SRS from the UE). Each subarray's use in receiving the reference signal may introduce noise or otherwise cause an error in determining the UE location, and the error may differ between subarrays. As such, a device is configured to use different subsets of antenna components to calculate one or more positioning measurements (such as a time of arrival (TOA), an angle of arrival (AoA), or a zenith of arrival (ZoA) of the reference signal). With each of the antenna components associated with a bias in calculating the one or more positioning measurements, each subset of antenna components is associated with an overall bias in calculating the one or more positioning measurements. The device is configured to generate and report an angle error group (AEG) report that is associated with the positioning measurements calculated (such as an AEG report including the positioning measurements and identifiers indicating the antenna components used to calculate each positioning measurement). The AEG report is used by a location server embodying a location management function (LMF) to identify the antenna components to be used for UE positioning or is used to identify a most accurate positioning measurement included in the AEG report, with the identified positioning measurement used to determine a position of the UE with reference to the base station. For example, the location server may select the subset of antenna subarrays from an antenna array of a base station or a UE to be used to receive an SRS or a PRS for UE positioning. In another example, the location server may identify the positioning measurements to be used in calculating a position of the UE, and the position of the UE may be used for one or more applications, such as navigation, handover, cell selection, etc.

In one implementation, a method for supporting positioning of a UE in a wireless network includes receiving, by an antenna system of a device, one or more reference signals from a second device. The antenna system includes a plurality of antenna components. The method also includes, for one or more subsets of antenna components from the plurality of antenna components, calculating, by a processing system of the device, one or more positioning measurements based on the one or more reference signals from the second device. Each of the one or more subsets of antenna components are associated with a bias in calculating the one or more positioning measurements, and each of the one or more subsets of antenna components are included in an angle error group (AEG) of one or more AEGs. The method further includes generating, by the processing system, an AEG report. The AEG report is associated with the one or more positioning measurements calculated by the device. The method also includes reporting the AEG report to another device in the wireless network.

In one implementation, a device configured for supporting positioning of a UE in a wireless network includes an antenna system including a plurality of antenna components, at least one transceiver coupled to the antenna system, at least one memory, and at least one processor coupled to the at least one transceiver and the at least one memory. The at least one processor is configured to receive, via the antenna system and the at least transceiver, one or more reference signals from a second device. The at least one processor is also configured to, for one or more subsets of antenna components from the plurality of antenna components, calculate one or more positioning measurements based on the one or more reference signals from the second device. Each of the one or more subsets of antenna components are associated with a bias in calculating the one or more positioning measurements, and each of the one or more subsets of antenna components are included in an AEG of one or more AEGs. The at least one processor is further configured to generate an AEG report. The AEG report is associated with the one or more positioning measurements. The at least one processor is also configured to report, via the at least one transceiver, the AEG report to another device in the wireless network.

In one implementation, a non-transitory computer-readable medium includes instructions that, when executed by at least one processor of a device configured for supporting positioning of a UE in a wireless network, cause the device to receive one or more reference signals from a second device. Execution of the instructions also causes the device to, for one or more subsets of antenna components from the plurality of antenna components, calculate one or more positioning measurements based on the one or more reference signals from the second device. Each of the one or more subsets of antenna components are associated with a bias in calculating the one or more positioning measurements, and each of the one or more subsets of antenna components are included in an AEG of one or more AEGs. Execution of the instructions also causes the device to generate an AEG report. The AEG report is associated with the one or more positioning measurements calculated by the device. Execution of the instructions also cause the device to report the AEG report to another device in the wireless network.

In one implementation, a device configured for supporting positioning of a UE in a wireless network includes means for receiving one or more reference signals from a second device using an antenna system. The antenna system includes a plurality of antenna components. The device also includes, for one or more subsets of antenna components from the plurality of antenna components, means for calculating one or more positioning measurements based on the one or more reference signals from the second device. Each of the one or more subsets of antenna components are associated with a bias in calculating the one or more positioning measurements, and each of the one or more subsets of antenna components are included in an AEG of one or more AEGs. The device further includes means for generating an AEG report. The AEG report is associated with the one or more positioning measurements calculated by the device. The device also includes means for reporting the AEG report to another device in the wireless network.

In one implementation, a method for supporting positioning of a UE in a wireless network includes receiving an AEG report generated by a device in the wireless network. The AEG report includes a plurality of positioning measurements calculated by the device and a plurality of AEG identifiers (IDs). Each positioning measurement is associated with an AEG of the device including one or more subsets of antenna components of the device, and each AEG ID of the plurality of AEG IDs corresponds to a positioning measurement of the plurality of positioning measurements. The method also includes identifying a positioning measurement in the AEG report based on the plurality of AEG IDs in the AEG report. The identified positioning measurement is to be used for estimating a position of the UE.

In one implementation, a location server configured for supporting positioning of a UE in a wireless network includes at least one transceiver, at least one memory, and at least one processor coupled to the at least one transceiver and the at least one memory. The at least one processor is configured to receive, via the at least one transceiver, an AEG report generated by a device in the wireless network. The AEG report includes a plurality of positioning measurements calculated by the device and a plurality of AEG IDs. Each positioning measurement is associated with an AEG of the device including one or more subsets of antenna components of the device, and each AEG ID of the plurality of AEG IDs corresponds to a positioning measurement of the plurality of positioning measurements. The at least one processor is also configured to identify a positioning measurement in the AEG report based on the plurality of AEG IDs in the AEG report. The identified positioning measurement is to be used for estimating a position of the UE.

In one implementation, a non-transitory computer-readable medium includes instructions that, when executed by at least one processor of a location server configured for supporting positioning of a UE in a wireless network, cause the location server to receive an AEG report generated by a device in the wireless network. The AEG report includes a plurality of positioning measurements calculated by the device and a plurality of AEG IDs. Each positioning measurement is associated with an AEG of the device including one or more subsets of antenna components of the device, and each AEG ID of the plurality of AEG IDs corresponds to a positioning measurement of the plurality of positioning measurements. Execution of the instructions also causes the location server to identify a positioning measurement in the AEG report based on the plurality of AEG IDs in the AEG report. The identified positioning measurement is to be used for estimating a position of the UE.

In one implementation, a location server configured for supporting positioning of a UE in a wireless network includes means for receiving an AEG report generated by a device in the wireless network. The AEG report includes a plurality of positioning measurements calculated by the device and a plurality of AEG IDs. Each positioning measurement is associated with an AEG of the device including one or more subsets of antenna components of the device, and each AEG ID of the plurality of AEG IDs corresponds to a positioning measurement of the plurality of positioning measurements. The location server also includes means for identifying a positioning measurement in the AEG report based on the plurality of AEG IDs in the AEG report. The identified positioning measurement is to be used for estimating a position of the UE.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an exemplary wireless communications system, according to various aspects of the disclosure.

FIG. 2 illustrates a block diagram of a design of a base station and user equipment (UE), which may be one of the base stations and one of the UEs in FIG. 1.

FIG. 3 illustrates a UE capable of supporting positioning of the UE in a wireless network.

FIG. 4 illustrates a base station capable of supporting positioning of a UE in a wireless network.

FIG. 5 illustrates a server capable of supporting positioning of a UE in a wireless network.

FIG. 6 is a diagram illustrating an exemplary technique for determining a position of a mobile device with reference to a base station.

FIG. 7 shows a flowchart for an exemplary method for supporting positioning of a UE in a wireless network.

FIG. 8 shows a flowchart for an exemplary method for identifying one or more angle error groups (AEGs) for use by a device to receive one or more reference signals.

FIG. 9 shows a flowchart for another exemplary method for identifying one or more AEGs for use by a device to receive one or more reference signals.

FIG. 10 shows a flowchart for an exemplary method for using the AEG reports received from one or more devices.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” (BS) are not intended to be specific or otherwise limited to any particular Radio Access Technology (RAT), unless otherwise noted. In general, a UE may be any wireless communication device (e.g., a mobile phone, router, tablet computer, laptop computer, tracking device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” a “mobile device,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the IEEE 802.11 set of standards, etc.) and so on.

A base station may operate according to one of several RATs in communication with UEs depending on the network in which it is deployed, and may be alternatively referred to as an access point (AP), a network node, a NodeB, an evolved NodeB (eNB), a New Radio (NR) Node B (also referred to as a gNodeB or gNB), etc. In addition, in some systems a base station may provide purely edge node signaling functions while in other systems it may provide additional control and/or network management functions. A communication link through which UEs can send signals to a base station is called an uplink (UL) or reverse link channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). A communication link through which UEs can send signals to or from each other is called a sidelink (SL). As used herein the term traffic channel (TCH) can refer to either an UL/reverse or DL/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). In some implementations, a TRP may be a UE.

To support positioning of a UE, two broad classes of positioning solutions have been defined: control plane based and user plane based. With reference to control plane (CP) positioning, signaling related to positioning and support of positioning may be carried over existing network (and UE) interfaces and using existing protocols dedicated to the transfer of signaling. With reference to user plane (UP) positioning, signaling related to positioning and support of positioning may be carried as part of other data using such protocols as the Internet Protocol (IP), Transmission Control Protocol (TCP) and User Datagram Protocol (UDP). As used herein, “positioning” may also be referred to as “locationing,” “position locationing,” “wireless locationing,” “UE locationing,” or the like.

The Third Generation Partnership Project (3GPP) has defined control plane positioning solutions for UEs that use radio access according to Global System for Mobile communications GSM (2G), Universal Mobile Telecommunications System (UMTS) (3G), LTE (4G) and New Radio (NR) for Fifth Generation (5G). These solutions are defined in 3GPP Technical Specifications (TSs) 23.271 and 23.273 (common parts), 43.059 (GSM access), 25.305 (UMTS access), 36.305 (LTE access) and 38.305 (NR access). For UP positioning, release 16 of the 3GPP standard for NR defines multi-cell round trip time (RTT), DL angle of departure (AoD), and UL angle of arrival (AoA) with zenith and azimuth. Release 16 also defines UE-based positioning associated with DL-TDOA and DL-AOD, DL-positioning reference signal (PRS) (DL-PRS), and sounding reference signal (SRS) for positioning. Release 16 also defines beam-specific (PRS) operation for mmWave and broadcasting of assistance data for positioning. Release 17 of the 3GPP standard for NR may define UE-initiated on-demand transmission of a DL-PRS, network-initiated on-demand transmission of a DL-PRS, Radio Resource Control (RRC) inactive DL-only, UL-only, or DL+UL based positioning, access point (AP) DL-PRS transmission, and/or aggregation of DL-PRS across multiple frequencies. Release 17 of the 3GPP standard for NR may also device transmission of sounding reference signals (SRS) from a UE on an uplink to a base station. The Open Mobile Alliance (OMA) has similarly defined a UP positioning solution known as Secure User Plane Location (SUPL), which can be used to locate a UE accessing any of a number of radio interfaces that support IP packet access such as General Packet Radio Service (GPRS) with GSM, GPRS with UMTS, or IP access with LTE or NR.

Both CP and UP based positioning (also referred to as location or locationing) solutions may employ a location server to support positioning of a UE. The location server may be part of or accessible from a serving network or a home network for a UE or may simply be accessible over the Internet or over a local Intranet. If positioning of a UE is needed, a location server may instigate a session (e.g. a location session or a SUPL session) with the UE and coordinate location measurements for the UE to determine an estimated location of the UE. During a location session, a location server may request positioning capabilities of a UE or base station (or the UE or base station may provide them without a request) and may request a location estimate or location measurements for a UE for various positioning techniques, e.g., for the Global Navigation Satellite System (GNSS), Time Difference of Arrival (TDOA), Angle of Departure (AoD), Round Trip Time (RTT) or multi cell RTT (Multi-RTT), and/or Enhanced Cell ID (ECID) position methods. The request for positioning capabilities may include a request as to whether the UE or base station supports multiple angle error groups (AEGs) and/or how many AEGs, such as described below.

A type of positioning technique (which may be defined in the 3GPP set of standards) is an angle of arrival (AoA) technique, which includes measuring the AoA (and possibly a zenith of arrival (ZoA) if not included in the AoA) of a reference signal received at the device. An AoA technique may be performed at a base station for measuring a received sounding reference signal (SRS) that is transmitted by a UE or may be performed at the UE for measuring a received positioning reference signal (PRS) that is transmitted by the base station. The AoA indicates the direction of the UE from the base station, and a ZoA indicates the elevation of the UE with reference to the base station. To note, the AoA may include the ZoA such that the AoA is in a three dimensional space. The UE or base station may also measure a TOA, which may be used to determine the distance of the UE from the base station.

In the case of 3GPP CP location, a location server may be an enhanced serving mobile location center (E-SMLC) in the case of LTE access, a standalone SMLC (SAS) in the case of UMTS access, a serving mobile location center (SMLC) in the case of GSM access, or a Location Management Function (LMF) in the case of 5G NR access.

In the case of OMA SUPL location, a location server may be a SUPL Location Platform (SLP) which may act as any of: (i) a home SLP (H-SLP) if in or associated with the home network of a UE or if providing a permanent subscription to a UE for location services; (ii) a discovered SLP (D-SLP) if in or associated with some other (non-home) network or if not associated with any network; (iii) an Emergency SLP (E-SLP) if supporting location for an emergency call instigated by the UE; or (iv) a visited SLP (V-SLP) if in or associated with a serving network or a current local area for a UE.

During a positioning session, a location server, base station, and/or UE may exchange messages defined according to a positioning protocol in order to coordinate the determination of an estimated location. Possible positioning protocols may include, for example, the LTE Positioning Protocol (LPP) defined by 3GPP in 3GPP TS 36.355 and the LPP Extensions (LPPe) protocol defined by OMA in OMA TSs OMA-TS-LPPe-V1_0, OMA-TS-LPPe-V1_1 and OMA-TS-LPPe-V2_0. The LPP and LPPe protocols may be used in combination where an LPP message contains one embedded LPPe message. The combined LPP and LPPe protocols may be referred to as LPP/LPPe. LPP and LPP/LPPe may be used to help support the 3GPP control plane solution for LTE or NR access, in which case LPP or LPP/LPPe messages may be exchanged between a UE and E-SMLC or between a UE and LMF. LPP or LPPe messages may be exchanged between a UE and E-SMLC via a serving Mobility Management Entity (MME) and a serving eNodeB for the UE. LPP or LPPe messages may also be exchanged between a UE and LMF via a serving Access and Mobility Management Function (AMF) and a serving NR Node B or gNodeB (gNB) for the UE. LPP and LPP/LPPe may also be used to help support the OMA SUPL solution for many types of wireless access that support IP messaging (such as LTE, NR and WiFi), where LPP or LPP/LPPe messages are exchanged between a SUPL Enabled Terminal (SET), which is the term used for a UE with SUPL, and an SLP, and may be transported within SUPL messages such as a SUPL POS or SUPL POS INIT message

A location server and a base station (e.g., an eNodeB for LTE access or a gNB for NR access) may exchange LPP or NR positioning protocol (NRPP) messages to enable the base station to perform one or more measurements for positioning or to configure the location server and base station to obtain by the location server position measurements for a particular UE from the base station. In the case of LTE access, the LPP A (LPPa) protocol may be used to transfer such messages between a base station that is an eNodeB (eNB) and a location server that is an E-SMLC. In the case of NR access, the NRPP A protocol may be used to transfer such messages between a base station that is a gNodeB (gNB) and a location server that is an LMF. It is noted that the terms “parameter” and “information element” (IE) are synonymous and are used interchangeably herein.

During positioning using signaling in LTE and 5G NR, a UE may acquire dedicated positioning signals transmitted by base stations, e.g., a positioning reference signal (PRS), which are used to generate the desired measurements for the supported positioning technique, e.g., an AoA, ZoA and/or TOA. PRS is defined for 5G NR positioning to enable UEs to detect and measure neighbor base stations or Transmission and Reception Points (TRPs). Downlink (DL) PRS may be received by a UE from a reference base station and/or one or more neighboring stations and used to generate the desired measurements for the supported positioning technique, e.g., an AoA, ZoA, and/or TOA. Based on the TOA of the PRS from the reference and neighboring base stations, the UE may generate DL Reference Signal Time Difference (RSTD) for DL TDOA positioning, sometimes referred to as Observed Time Difference of Arrival (OTDOA). In a similar process, the UE may transmit uplink (UL) references signals for positioning, referred to as Sounding Reference Signals (SRS) for positioning to a reference base station and neighboring base stations. A base station may receive an SRS and generate the desired measurements for the supported positioning technique, e.g., an AoA, ZoA, and/or TOA. The TOAs of the SRS at the reference and neighboring stations may be used to generate an UL RSTD of UL TDOA positioning, sometimes referred to as UL Time Difference of Arrival (UTDOA). The positioning measurements may be provided to the location server to determine a location of the UE in the wireless network or to perform other operations of the wireless network (such as cell selection, navigation, or other operations). As used herein, a positioning measurement may be referred to as a UE positioning measurement. A UE positioning measurement is a measurement of a position of a UE with reference to a base station. A UE positioning measurement may refer to a positioning measurement measured by a base station using one or more SRSs from a UE or a positioning measurement measured by a UE using one or more PRSs from a base station. As such, the phrase “UE positioning measurement” does not necessarily indicate the device performing the measurement and “positioning measurement” and “UE positioning measurement” may be used interchangeably throughout the present disclosure.

A base station or a UE includes an antenna system that includes a plurality of antenna components to receive a reference signal. Each antenna component can cause an error in the UE positioning measurements. For example, a base station or UE may include an antenna array having a plurality of subarrays. Each subarray is separately arranged and controlled such that the subarray is associated with a unique noise or interference for a received signal. For example, one or more subarrays may use one oscillator and one or more other subarrays may use a different oscillator for driving the subarrays. In another example, the direction of configuration of a subarray may cause a subarray to receive a reference signal along a non-line of sight (NLOS) path instead of a line of sight (LOS) path. In another example, a wireless channel used by one subarray may have more noise or interference than another channel used by another subarray. The different oscillators, directionality, and other variations in the subarrays may cause a unique error in the UE location measurements for a reference signal received by a particular subarray.

The antenna array may be configured to be used as a phased array. As such, a subset of subarrays is used to receive a reference signal. With each subarray being associated with an error in performing a UE positioning measurement, the subset of subarrays is associated with an error in performing a UE positioning measurement, with the error being based on a combination of the errors of the subset of subarrays. Similarly, a device may include a plurality of antennas, and each antenna may be associated with an error in generating a UE positioning measurement for a reference signal received by the antenna. As such, if a subset of antennas is used to receive a reference signal, the subset of antennas may be associated with an error that is a combination of the errors associated with the antennas in the subset. Antenna components other than subarrays, antennas, and oscillators may also cause noise or interference or otherwise cause an error in generating a UE positioning measurement (such as contact points, lines leading between components, front end components, power sources or rails, and so on).

In the specific examples described herein, a base station may perform UL AoA positioning techniques using an SRS received from a UE, or a UE may perform DL AoA positioning techniques using a PRS received from a base station. AoA positioning techniques include measuring one or more of an AoA, a ZoA, or a TOA of a received reference signal, which may be used to determine a location of UE with reference to a base station. For example, using received DL PRS from a base station, and/or using received UL SRS from a UE, a UE or a base station (such as a gNB) may perform various positioning measurements (also referred to as position measurements, positioning measurements, UE positioning measurements, and the like). For UL AoA positioning techniques at a base station receiving one or more SRSs from a UE, the base station may measure one or more of an AoA, a ZoA, or a TOA of an SRS. For DL AoA positioning techniques at a UE receiving one or more PRSs from a base station, the UE may measure one or more of an AoA, a ZoA, or a TOA of a PRS. The AoA, ZoA, or another suitable angle measurement may be impacted by which antenna (or other antenna components) are to be used to receive the reference signal to generate an angle measurement. For example, if directional antennas are used, the directionality of the antenna impacts the angle measurement. In another example, if an antenna array with subarrays controlled using different oscillators is used to configure the antenna array as a phased array, the different errors or noise in the different oscillators have different impacts on an angle measurement. For example, a first subarray's oscillator may have a higher noise or otherwise cause more error in an angle measurement than a second subarray's oscillator.

To improve the accuracy of the angle measurements and subsequently determined UE location, a group of antenna components associated with a smaller error (also referred to as bias) than other antenna components may be configured to receive a specific reference signal to be used for generating one or more angle measurements. While some error in an angle measurement (an angle error) may be attributed to a static error without reference to the location of the transmission source of a reference signal (such as a constant noise from an oscillator), some angle error may be attributed to an error based on the location of the transmission source of the reference signal. For example, a directional antenna may cause more error in an angle measurement for a reference signal received outside of the direction of the antenna (such that the antenna receives a NLOS signal along a reflection path) than for an angle measurement for a reference signal received in the direction of the antenna (such that the antenna receives an LOS signal). Similarly, a subarray may cause a different angle error based on the location of the transmission source of the reference signal.

As such, which components that are to be configured for use in receiving a reference signal (such as which subarrays of an antenna array or which antennas of a plurality of antennas in general) may be associated with the location of the device transmitting the reference signal with reference to the device receiving the reference signal and generating the angle measurements. Which antenna components are to be used to receive a future reference signal may be determined by the measuring device (such as a base station for UL AoA positioning techniques or a UE for DL AoA positioning techniques), a location server, or another device in the network (such as BS for a UE for DL AoA positioning techniques) based on one or more angle measurements for previous and/or current reference signals received by the measuring device. To note, the examples herein describe a location server determining and indicating the antenna components to be used for receiving a reference signal. For a location server to determine which antenna components are to be used at the measuring device, the measuring device may report the angle measurements, an angle error associated with an angle measurement, and/or an identifier associated with the antenna components used to receive a reference signal to generate the angle measurement. Which subset of antenna components are to be used may be selected based on reducing the error in the UE positioning measurements generated from a reference signal received by the subset of antenna components.

As described herein, different subsets of antenna components may be used to receive a reference signal. For each received reference signal, a UE positioning measurement may be generated from the received reference signal. In some implementations, an error may be determined from the measurement. The errors may be used (such as by a location server) to determine which subset of antenna components are to be used to receive future reference signals. For AoA positioning techniques, the error is an angle error (such as with reference to an AoA or a ZoA). A subset of antenna components may be referred to as an angle error group (AEG) that is associated with an angle error that may vary based on the transmission location of the reference signal received to generate the angle error. A device may generate an AEG report including angle measurements or angle errors associated with a plurality of AEGs used to receive one or more reference signals, and the device may provide the AEG report to another device (with a location server to ultimately receive the AEG report or its contents). For example, a UE may receive a PRS using an antenna system, generate angle measurements from the PRS for different AEGs of the antenna system, possibly measure angle errors for the different angle measurements, and generate an AEG report that is provided to a base station via a UL or another UE via a sidelink (SL), with the AEG report to ultimately be received by a location server. In another example, a base station may receive an SRS using an antenna system, generate angle measurements from the SRS for different AEGs of the antenna system, possibly measure angle errors for the different angle measurements, and generate an AEG report that is provided to a core network component, with the AEG report to ultimately be received by a location server coupled to the core network. The location server may determine the AEG to be used by the base station or UE based on the AEG report. To note, the angle errors may not be measured or known in some implementations. As such, the location server may identify an angle measurement to be used without explicitly knowing the associated angle error (such as described below).

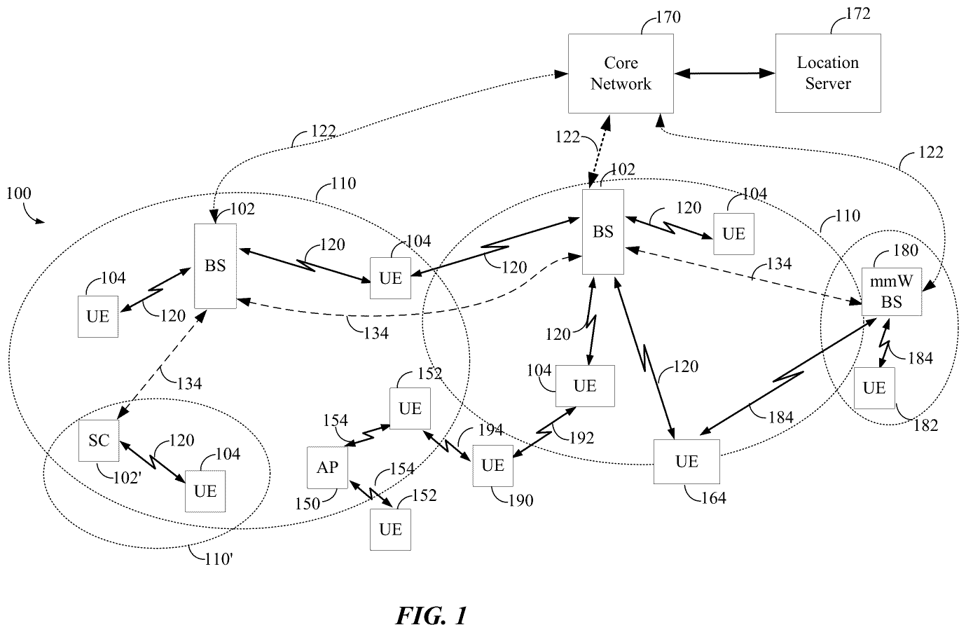

FIG. 1 illustrates an exemplary wireless communications system 100. The wireless communications system 100 (which may also be referred to as a wireless wide area network (WWAN) or a wireless network (e.g., a cellular network)) may include various base stations 102 and various UEs 104, which one or more of the base stations 102 and/or UEs 104 may sometimes be referred to herein as TRPs 102 or 104. The base stations 102 may include macro cell base stations (high power cellular base stations) and/or small cell base stations (low power cellular base stations). In an aspect, the macro cell base station may include eNBs where the wireless communications system 100 corresponds to an LTE network, or gNBs where the wireless communications system 100 corresponds to a 5G network, or a combination of both, and the small cell base stations may include femtocells, picocells, microcells, etc.

The base stations 102 may collectively form a RAN and interface with a core network 170 (e.g., an evolved packet core (EPC) or next generation core (NGC)) through backhaul links 122, and through the core network 170 to a location server 172, which may include one or more location servers. In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/NGC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station or UE (e.g., over some frequency resource, referred to as a carrier frequency, component carrier, carrier, band, or the like), and may be associated with an identifier (e.g., a physical cell identifier (PCID), a virtual cell identifier (VCID)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include UL (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to DL and UL (e.g., more or less carriers may be allocated for DL than for UL).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or 5G technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. LTE in an unlicensed spectrum may be referred to as LTE-unlicensed (LTE-U), licensed assisted access (LAA), or MulteFire.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), signal-to-noise ratio (SNR), etc.) of the RF signals received from that direction.

For receive beamforming being performed to receive a reference signal for UE positioning (e.g., an SRS transmitted by a UE or a PRS transmitted by a base station), the subarrays of the antenna array are each associated with an error in generating a UE positioning measurement (such as an AoA or a ZoA). In some aspects, a subset of subarrays may be determined to be used for UE positioning based on the errors. While the example is described with reference to a subset of subarrays, a subset of any suitable antenna components may be determined to be used for UE positioning (such as a subset of antennas from a plurality of antennas).

In 5G, the frequency spectrum in which wireless nodes (e.g., base stations 102/180, UEs 104/182) operate is divided into multiple frequency ranges, FR1 (from 450 to 6000 MHz), FR2 (from 24250 to 52600 MHz), FR3 (above 52600 MHz), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the primary carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels. A secondary carrier is a carrier operating on a second frequency (e.g., FR2) that may be configured once the RRC connection is established between the UE 104 and the anchor carrier and that may be used to provide additional radio resources. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be a primary carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz) compared to that attained by a single 20 MHz carrier. Transmission of reference signals, AEG reports, requests for AEG reports, configuration information for setting a positioning session, or other communications that may occur between a base station and a UE may be performed using any suitable carrier.

The wireless communications system 100 may further include one or more UEs, such as UE 190, that connects indirectly to one or more communication networks via one or more sidelinks (SLs), such as device-to-device (D2D) peer-to-peer (P2P) links. In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WiFi Direct (WiFi-D), Bluetooth®, and so on. In the example, the UE 190 may be a relay UE between the UE 152 and a base station 102. One or multiple UEs may be relay UEs between a device and a base station.

The wireless communications system 100 may further include a UE 164 that may communicate with a macro cell base station 102 over a communication link 120 and/or the mmW base station 180 over a mmW communication link 184. For example, the macro cell base station 102 may support a PCell and one or more SCells for the UE 164 and the mmW base station 180 may support one or more SCells for the UE 164.

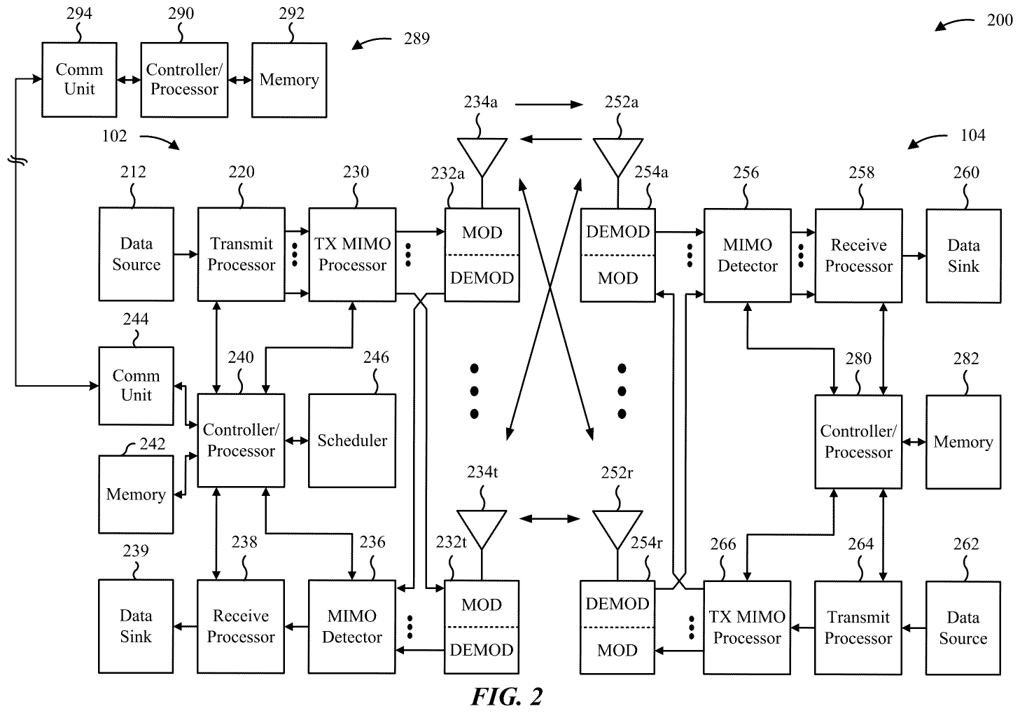

A target UE 104 for positioning may be within wireless range of one or more base stations 102 (which may be TRPs 102 for positioning of the target UE 104). For UE positioning, a base station may transmit a PRS on a DL to one or more target UEs, or a target UE may transmit an SRS on an UL to one or more base stations. In some aspects, the receiving device measures the AoA and/or ZoA of the SRS or PRS, possibly determines an angle error associated with the measurements, and generates an AEG report to include the angle measurements, the angle errors, or other suitable UE positioning measurements. An example UE and base station to perform the described operations are depicted in FIGS. 2-4.

FIG. 2 shows a block diagram of a design 200 of base station 102 and UE 104, which may be one of the base stations and one of the UEs in FIG. 1. Base station 102 may be equipped with T antennas 234a through 234t, and UE 104 may be equipped with R antennas 252a through 252r, where in general T≥1 and R≥1. In some implementations, T antennas 234a through 234t or R antennas 252a through 252r may be part of an antenna array (which may be configured to operate as a phased array). For example, each antenna 234a through 234t may represent a subarray of an antenna array, with the subarray including a plurality of antennas. For implementation considerations, an antenna array may have multiple antennas that are configured together (with the multiple antennas making up a subarray). As such, the power and frequency used to control the antennas of the subarray is the same, allowing fewer oscillators and power supplies to be required than if each antenna is independently configured in the antenna array. In another example, each antenna 234a through 234t or antenna 252a through 252r may be a single antenna.

At base station 102, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., a cell-specific reference signal (CRS) or PRS). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, T antennas 234a through 234t may also receive one or more SRSs from UE 104 or transmit one or more PRSs to UE 104.

At UE 104, antennas 252a through 252r may receive the downlink signals from base station 102 and/or other base stations and may provide received signals to demodulators (DEMODs) 254a through 254r, respectively. Each demodulator 254 may condition (e.g., filter, amplify, down convert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor (such as the receive processor 258 or the controller/processor 280) may determine reference signal received power (RSRP), received signal strength indicator (RSSI), reference signal received quality (RSRQ), channel quality indicator (CQI), and/or the like. In some implementations, the controller/processor 280 may measure an AoA, a ZoA, a TOA, and/or other measurements of a PRS received by antennas 252a through 252r. In some aspects, one or more components of UE 104 may be included in a housing.

On the uplink, at UE 104, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals (such as an SRS). The symbols from transmit processor 264 may be precoded by a TX MIMO processor 266 if applicable, further processed by modulators 254a through 254r (e.g., for DFT-s-OFDM, CP-OFDM, and/or the like), and transmitted to base station 102. At base station 102, the uplink signals from UE 104 and other UEs may be received by antennas 234, processed by demodulators, detected by a MIMO detector 236 if applicable, and further processed by a receive processor 238 to obtain decoded data and control information sent by UE 104. Receive processor 238 may provide the decoded data to a data sink 239 and the decoded control information to controller/processor 240. In some implementations, the controller/processor 240 may measure an AoA, a ZoA, a TOA, and/or other measurements of an SRS received by antennas 234a through 234t. Base station 102 may include communication unit 244 and communicate to network controller 289 via communication unit 244. Network controller 289 may include communication unit 294, controller/processor 290, and memory 292. The network controller 289 may be location server 172, which may be coupled to the base station 102 via core network 170.

Controller/processor 240 of base station 102, controller/processor 280 of UE 104, controller 290 of network controller 289, which may be location server 172, and/or any other component(s) of FIG. 2 may perform one or more techniques associated with supporting positioning services for a UE, as described in more detail elsewhere herein. For example, controller/processor 240 of base station 102, controller 290 of network controller 289, controller/processor 280 of UE 104, and/or any other component(s) of FIG. 2 may perform or direct operations of, for example, the processes depicted in the Figures and as described herein. Memories 242, 282, and 292 may store data and program codes for base station 102, UE 104, and network controller 289, respectively. In some aspects, memory 242 and/or memory 282 and/or memory 292 may comprise a non-transitory computer-readable medium storing one or more instructions for wireless communication. For example, the one or more instructions, when executed by one or more processors of base station 102, network controller 289, and/or the UE 104 may perform or direct operations of the processes described herein. A scheduler 246 may schedule UEs for data transmission on the downlink and/or uplink.

The location server 172 (which may include the network controller 289) may be configured to select or indicate which antenna components are to be used to receive a reference signal for UE positioning, to determine a configuration of one or more reference signals for UE positioning, to determine a position of one or more UEs in the wireless network, to store positioning information for the one or more UEs, or to perform other operations associated with positioning of one or more UEs in the wireless network. The positioning information may be used for various operations, such as cell selection, handover, navigation, beamforming, or other aspects of a wireless network 100.

As indicated above, FIG. 2 is provided as an example. Other examples may differ from what is described with regard to FIG. 2. For example, while FIG. 2 depicts communication between a base station 102 and a UE 104, communications may occur between multiple base stations 102 and/or multiple UEs 104.

A base station may broadcast, unicast, or groupcast one or more PRSs in a wireless network (such as in a cellular network including LTE technologies and/or 5G technologies). In a frequency domain, an available bandwidth may be divided into uniformly spaced orthogonal subcarriers (also referred to as “tones” or “bins”). For example, for a normal length cyclic prefix (CP) using, for example, 15 kHz spacing, subcarriers may be grouped into a group of twelve (12) subcarriers. A resource of one OFDM symbol length in the time domain and one subcarrier in the frequency domain may be referred to as a resource element (RE). In the example, each grouping of 12 subcarriers and 14 OFDM symbols is termed a resource block (RB) and, in the example above, the number of subcarriers in the resource block may be written as N_{SC}^{RB}=12. For a given channel bandwidth, the number of available resource blocks on each channel, which is also called the transmission bandwidth configuration, is indicated as N_{RB}^{DL}. For example, for a 3 MHz channel bandwidth in the above example, the number of available resource blocks on each channel is given by N_{RB}^{DL}=15. Note that the frequency component of a resource block (e.g., the 12 subcarriers) is referred to as a physical resource block (PRB).

A base station may transmit radio frames, or other physical layer signaling sequences, supporting PRS signals (i.e., a downlink (DL) PRS) according to frame configurations similar to the above example, which may be measured and used for a target UE position estimation. Other types of wireless nodes (e.g., a distributed antenna system (DAS), remote radio head (RRH), AP, etc.) in a wireless network may also be configured to transmit PRSs configured in a manner similar to (or the same as) described above.

A collection of resource elements that are used for transmission of PRS signals is referred to as a “PRS resource.” The collection of resource elements can span multiple PRBs in the frequency domain and N (e.g., 1 or more) consecutive symbol(s) within a slot in the time domain. A “PRS resource set” is a set of PRS resources used for the transmission of PRS signals, where each PRS resource has a PRS resource identifier (ID). In addition, the PRS resources in a PRS resource set are associated with the same TRP. A PRS resource ID in a PRS resource set is associated with a single beam transmitted from a single TRP (where a TRP may transmit one or more beams). Note that this does not have any implications on whether the TRPs and beams from which signals are transmitted are known to the UE.

A PRS may be transmitted in special positioning subframes that are grouped into positioning occasions. A PRS occasion is one instance of a periodically repeated time window (e.g., consecutive slot(s)) where PRSs are expected to be transmitted. Each periodically repeated time window can include a group of one or more consecutive PRS occasions. Each PRS occasion can include a number NPRS of consecutive positioning subframes. The PRS positioning occasions for a cell supported by a base station or a UE may occur periodically at intervals. Multiple PRS occasions may be associated with the same PRS resource configuration, in which case, each such occasion is referred to as an “occasion of the PRS resource” or the like.

A PRS may be transmitted with a constant power. A PRS can also be transmitted with zero power (i.e., muted). Muting, which turns off a regularly scheduled PRS transmission, may be useful when PRS signals between different cells overlap by occurring at the same or almost the same time. In this case, the PRS signals from some cells may be muted while PRS signals from other cells are transmitted (e.g., at a constant power). Muting may aid signal acquisition and time of arrival (TOA) and reference signal time difference (RSTD) measurement, by UEs, of PRS signals that are not muted (by avoiding interference from PRS signals that have been muted). Muting may be viewed as the non-transmission of a PRS for a given positioning occasion for a particular cell. Muting patterns (also referred to as muting sequences) may be signaled (e.g., using the LTE positioning protocol (LPP)) to a UE using bit strings. For example, in a bit string signaled to indicate a muting pattern, if a bit at position j is set to ‘0’, then the UE may infer that the PRS is muted for a j^{th} positioning occasion.

To further improve hearability of PRS, positioning subframes may be low-interference subframes that are transmitted without user data channels. As a result, in ideally synchronized networks, PRS may be interfered with by other cells' PRS with the same PRS pattern index (i.e., with the same frequency shift), but not from data transmissions. The frequency shift may be defined as a function of a PRS ID for a cell or other transmission point (TP) (denoted as N_{ID}^{RPS}) or as a function of a physical cell identifier (PCI) (denoted as N_{ID}^{cell}) if no PRS ID is assigned, which results in an effective frequency re-use factor of six (6).

To also improve hearability of a PRS (e.g., when PRS bandwidth is limited, such as with only six resource blocks corresponding to 1.4 MHz bandwidth), the frequency band for consecutive PRS positioning occasions (or consecutive PRS subframes) may be changed in a known and predictable manner via frequency hopping. In addition, a cell supported by a base station or a UE may support more than one PRS configuration, where each PRS configuration may comprise a distinct frequency offset (vshift), a distinct carrier frequency, a distinct bandwidth, a distinct code sequence, and/or a distinct sequence of PRS positioning occasions with a particular number of subframes (NPRS) per positioning occasion and a particular periodicity (T_{PRS}). In some implementation, one or more of the PRS configurations supported in a cell may be for a directional PRS and may then have additional distinct characteristics, such as a distinct direction of transmission, a distinct range of horizontal angles, and/or a distinct range of vertical angles.

A PRS configuration, as described above, including the PRS transmission/muting schedule, is signaled to a UE to enable the UE to perform PRS positioning measurements (also referred to herein as UE positioning measurements). In this manner, the UE may not be expected to blindly perform detection of PRS configurations. Similar to the operations described above for transmitting a DL PRS by a base station, a target UE may transmit UL SRS for positioning, which is received by a base station to enable the base station to perform SRS positioning measurements (also referred to herein as UE positioning measurements). An SRS configuration may be similar to a PRS configuration used by a UE to configure the signal resources to be transmitted for the SRS (which may include one or more resource blocks referred to as SRS resources). As described herein, receiving a reference signal may refer to receiving one or more resources of the reference signal (such as one or more PRS resources or one or more SRS resources).

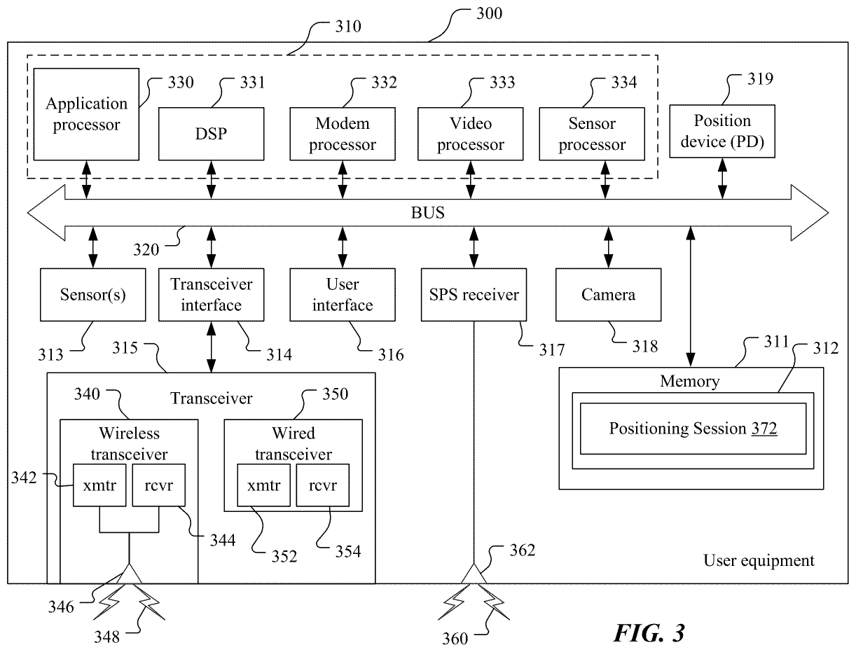

A subset of antenna components may be referred to as an AEG or may be included in an AEG if the AEG includes additional information. A measuring device may generate and provide an AEG report including any information to be reported to the location server. For example, a UE may transmit one or more measurement reports to a base station or another UE, and the one or more measurement reports are relayed to a location server. In another example, a base station may transmit one or more measurement reports to a core network component, and the one or more measurement reports are relayed through the core network to a location server. Some examples described herein are regarding the generation and reporting of an AEG report associated with one or more received reference signals. Some other examples described herein are regarding the use of one or more AEG reports to identify a positioning measurement included in the AEG report, which may be used to determine the antenna components to be used for receiving future reference signals, may be used to determine a location of the UE in the wireless network, or may be used to perform other suitable positioning operations (such as for navigation, cell selection, beamforming, handover, etc.). The operations performed in generating and reporting an AEG report and/or in using the AEG report are described below as being performed with reference to a measuring device (also referred to as a device, which may be a base station or a UE) and a location server. Example implementations of a UE, base station, and location server are described below with reference to FIGS. 3-5, respectively.

FIG. 3 illustrates a UE 300, which is an example of the UE 104, capable of supporting positioning services of the UE 300 in a wireless network (such as the wireless network 100). The UE 300 includes a computing platform including at least one processor 310, memory 311 including software (SW) 312, one or more sensors 313, a transceiver interface 314 for a transceiver 315, a user interface 316, a Satellite Positioning System (SPS) receiver 317, a camera 318, and a position device (PD) 319. The processor 310, the memory 311, the sensor(s) 313, the transceiver interface 314, the user interface 316, the SPS receiver 317, the camera 318, and the position device 319 may be communicatively coupled to each other by a bus 320 (which may be configured, e.g., for optical and/or electrical communication). One or more of the shown apparatus (e.g., the camera 318, the SPS receiver 317, and/or one or more of the sensor(s) 313, etc.) may be omitted from the UE 300. The processor 310 may include one or more intelligent hardware devices, e.g., a central processing unit (CPU), a microcontroller, an application specific integrated circuit (ASIC), etc. The processor 310 may comprise multiple processors including an application processor 330, a Digital Signal Processor (DSP) 331, a modem processor 332, a video processor 333, and/or a sensor processor 334. One or more of the processors 330-334 may comprise multiple devices (e.g., multiple processors). For example, the sensor processor 334 may comprise, e.g., processors for radar, ultrasound, and/or lidar, etc. The modem processor 332 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the UE 300 for connectivity. The memory 311 is a non-transitory storage medium that may include random access memory (RAM), flash memory, disc memory, and/or read-only memory (ROM), etc. The memory 311 stores the software 312 which may be processor-readable, processor-executable software code containing instructions that are configured to, when executed, cause the processor 310 to operate as a special purpose computer programmed to perform the various functions described herein. Alternatively, the software 312 may not be directly executable by the processor 310 but may be configured to cause the processor 310, e.g., when compiled and executed, to operate as a special purpose computer to perform the various functions described herein. The description may refer only to the processor 310 performing a function, but this includes other implementations such as where the processor 310 executes software and/or firmware. The description may refer to the processor 310 performing a function as shorthand for one or more of the processors 330-334 performing the function. The description may refer to the UE 300 performing a function as shorthand for one or more appropriate components of the UE 300 performing the function. The processor 310 may include a memory with stored instructions in addition to and/or instead of the memory 311.

The configuration of the UE 300 shown in FIG. 3 is an example and not limiting of the disclosure, including the claims, and other configurations may be used. For example, an example configuration of the UE includes one or more of the processors 330-334 of the processor 310, the memory 311, and the wireless transceiver 340. Other example configurations include one or more of the processors 330-334 of the processor 310, the memory 311, the wireless transceiver 340, and one or more antennas 346.

The UE 300 may comprise the modem processor 332 that may be capable of performing baseband processing of signals received and down-converted by the transceiver 315 and/or the SPS receiver 317. The modem processor 332 may perform baseband processing of signals to be upconverted for transmission by the transceiver 315. Also or alternatively, baseband processing may be performed by the processor 330 and/or the DSP 331. Other configurations, however, may be used to perform baseband processing.

The UE 300 may include the sensor(s) 313 that may include, for example, one or more of various types of sensors such as one or more inertial sensors, one or more barometric pressure sensors, one or more magnetometers, one or more environment sensors, one or more optical sensors, one or more weight sensors, and/or one or more radio frequency (RF) sensors, etc. An inertial measurement unit (IMU) may comprise, for example, one or more accelerometers (e.g., collectively responding to acceleration of the UE 300 in three dimensions) and/or one or more gyroscopes capable of detecting motion including rotation of the UE 300. The sensor(s) 313 may include one or more magnetometers to determine orientation (e.g., relative to magnetic north and/or true north) that may be used for any of a variety of purposes, e.g., to support one or more compass applications. The environment sensor(s) may comprise, for example, one or more temperature sensors, one or more barometric pressure sensors, one or more ambient light sensors, one or more camera imagers, and/or one or more microphones, etc. The sensor(s) 313 may generate analog and/or digital signals indications of which may be stored in the memory 311 and processed by the DSP 331 and/or the processor 330 in support of one or more applications such as, for example, applications directed to positioning and/or navigation operations.

The sensor(s) 313 may be used in relative location measurements, relative location determination, motion determination, etc. Information detected by the sensor(s) 313 may be used for motion detection, relative displacement, dead reckoning, sensor-based location determination, and/or sensor-assisted location determination. The sensor(s) 313 may be useful for calibration of a positioning session. For example, the sensor measurements may be used to determine a location of the UE, and the location of the UE may be used to determine an angle error associated with an angle measurement for the location. For example, for UL AoA based UE positioning, a measured location of the UE may be provided by the UE to a base station that receives an SRS from the UE or to a location server to receive the angle measurement of the SRS from the UE. A known location of the base station and the angle measurement may be compared by the base station or the location server to determine the angle error as the divergence of the angle measurement from the actual angle that should have been measured. For DL AoA based UE positioning, the UE receives a PRS from a base station and generates an angle measurement. The UE may also measure a location of the UE using the sensor measurements. The UE may receive the known location of the base station in order to determine an angle error based on the known location of the base station, the measured location of the UE, and the angle measurement from the received PRS. Alternatively, the UE may provide the measured location of the UE and the angle measurement to a location server that determines the angle error based on the known location of the base station transmitting the PRS, the measured location of the UE, and the angle measurement from the UE. Such angle error determinations may be performed multiple times to determine an angle error (which may be an average angle error, median angle error, or other aggregated angle error) for various UE locations around a base station. The UE location relative to the base station is associated with an angle measurement (e.g., an AoA and/or ZoA), and the angle error may be identified based on the angle measurement and the previously measured angle errors for similar angle measurements. Calibration that may be used to define the angle errors for different angle measurements is described in more detail below, for which the UE 300 may be a reference device for calibration. The sensor measurements may also indicate a movement of the UE, which may impact a decision as to the antenna components to be used for receiving a future reference signal or for other positioning operations.

The IMU may be configured to provide measurements about a direction of motion and/or a speed of motion of the UE 300, which may be used in relative location determination. For example, one or more accelerometers and/or one or more gyroscopes of the IMU may detect, respectively, a linear acceleration and a speed of rotation of the UE 300. The linear acceleration and speed of rotation measurements of the UE 300 may be integrated over time to determine an instantaneous direction of motion as well as a displacement of the UE 300. The instantaneous direction of motion and the displacement may be integrated to track a location of the UE 300. For example, a reference location of the UE 300 may be determined, e.g., using the SPS receiver 317 (and/or by some other means) for a moment in time and measurements from the accelerometer(s) and gyroscope(s) taken after this moment in time may be used in dead reckoning to determine a future location of the UE 300 based on movement (direction and distance) of the UE 300 relative to a present location.

The magnetometer(s) may determine magnetic field strengths in different directions which may be used to determine orientation of the UE 300. For example, the orientation may be used to provide a digital compass for the UE 300. The magnetometer may be a two-dimensional magnetometer configured to detect and provide indications of magnetic field strength in two orthogonal dimensions. Alternatively, the magnetometer may be a three-dimensional magnetometer configured to detect and provide indications of magnetic field strength in three orthogonal dimensions. The magnetometer may provide means for sensing a magnetic field and providing indications of the magnetic field, e.g., to the processor 310.

The barometric pressure sensors(s) may determine air pressure, which may be used to determine the elevation, which may impact the selection of antenna components for receiving a reference signal or may be used for calibration of the positioning session regarding measuring ZoA. For example, a differential pressure reading may be used indicate a change in elevation. A measured change in elevation may be used to track a future elevation of the UE, which may impact the selection of antenna components to receive a future reference signal from which a ZoA is measured. In another example, a pressure reading may be used to detect an elevation of the UE, and an elevation of a base station may be known. A difference in the measured elevation of the UE and the known elevation of the base station may be compared with a measured ZoA of a reference signal between the base station and UE to determine an angle error for the measured ZoA.

The transceiver 315 may include one or both of a wireless transceiver 340 or a wired transceiver 350 configured to communicate with other devices through wireless connections and wired connections, respectively. For example, the wireless transceiver 340 may include a transmitter 342 and receiver 344 coupled to one or more antennas 346 for transmitting (e.g., on one or more uplink channels and/or one or more sidelink channels) and/or receiving (e.g., on one or more downlink channels and/or one or more sidelink channels) wireless signals 348. In some implementations, the wireless signals 348 may be transduced to wired (e.g., electrical and/or optical) signals and from wired (e.g., electrical and/or optical) signals, and the wired signals may be transduced to the wireless signals 348. Thus, the transmitter 342 may include multiple transmitters that may be discrete components or combined/integrated components, and/or the receiver 344 may include multiple receivers that may be discrete components or combined/integrated components. The wireless transceiver 340 may be configured to communicate signals (e.g., with TRPs and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 6GPP LTE-V2X (PC5), IEEE 802.11 (including IEEE 802.11p), WiFi, WiFi Direct (WiFi-D), Bluetooth®, Zigbee etc. New Radio may use mm-wave frequencies and/or sub-6 GHz frequencies. If the UE 300 is to include a wired transceiver, the wired transceiver 350 may include a transmitter 352 and a receiver 354 configured for wired communication. The transmitter 352 may include multiple transmitters that may be discrete components or combined/integrated components, and/or the receiver 354 may include multiple receivers that may be discrete components or combined/integrated components. The wired transceiver 350 may be configured, e.g., for optical communication and/or electrical communication. The transceiver 315 may be communicatively coupled to the transceiver interface 314, e.g., by optical and/or electrical connection. The transceiver interface 314 may be at least partially integrated with the transceiver 315.

The antennas 346 may include an antenna array. The antenna array may be capable of transmit beamforming or receive beamforming, e.g., by increasing the gain setting and/or adjust the phase setting of an array of antennas in a particular direction to amplify (e.g., to increase the gain level of) the RF signals received from that direction. The antennas 346 may further include a plurality of antenna panels, wherein each antenna panel is capable of beamforming. The antennas 346 are capable of adaptation, e.g., selection of one or more antennas for controlling receiving transmitted beams from a base station. A reduced number of beams or a single beam, for example, may be selected for reception of a wide angle beam, e.g., to reduce power consumption, while an increased number of antennas in an antenna array may be selected when the transmit beam is relatively narrow. Instead of controlling each antenna of the antenna array individually, the antenna array may include a plurality of subarrays, with each subarray capable of being controlled independently. Alternatively, the antennas 346 may include a plurality of independently controlled antennas. As used herein for the UE 300, an antenna system including a plurality of antenna components may include one or more of the antennas 346, one or more components of the receiver 344, other components of the wireless transceiver 340 not shown (such as power supplies or rails), or other components of the UE 300 that may impact an angle error for UL AoA based UE positioning.

The user interface 316 may comprise one or more of several devices such as, for example, a speaker, microphone, display device, vibration device, keyboard, touch screen, etc. The user interface 316 may include more than one of any of these devices. The user interface 316 may be configured to enable a user to interact with one or more applications hosted by the UE 300. For example, the user interface 316 may store indications of analog and/or digital signals in the memory 311 to be processed by DSP 331 and/or the processor 330 in response to action from a user. Similarly, applications hosted on the UE 300 may store indications of analog and/or digital signals in the memory 311 to present an output signal to a user. The user interface 316 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 316 may comprise one or more touch sensors responsive to touching and/or pressure, e.g., on a keyboard and/or touch screen of the user interface 316.

The SPS receiver 317 (e.g., a Global Positioning System (GPS) receiver or other Global Navigation Satellite System (GNSS) receiver) may be capable of receiving and acquiring SPS signals 360 via an SPS antenna 362. The antenna 362 is configured to transduce the wireless signals 360 to wired signals, e.g., electrical or optical signals, and may be integrated with the antenna 346. The SPS receiver 317 may be configured to process, in whole or in part, the acquired SPS signals 360 for estimating a location of the UE 300. For example, the SPS receiver 317 may be configured to determine location of the UE 300 by trilateration/multilateration using the SPS signals 360. The processor 330, the memory 311, the DSP 331, the PD 319 and/or one or more additional specialized processors (not shown) may be utilized to process acquired SPS signals, in whole or in part, and/or to calculate an estimated location of the UE 300, in conjunction with the SPS receiver 317. The memory 311 may store indications (e.g., measurements) of the SPS signals 360 and/or other signals (e.g., signals acquired from the wireless transceiver 340) for use in performing positioning operations. The general-purpose processor 330, the DSP 331, the PD 319, and/or one or more additional specialized processors, and/or the memory 311 may provide or support a location engine for use in processing measurements to estimate a location of the UE 300. In some implementations, the estimated locations of the UE may be used for calibration of a positioning session, such as by determining angle errors associated with different locations of a UE with reference to a known location of a base station as described above.

The UE 300 may include the camera 318 for capturing still or moving imagery. The camera 318 may comprise, for example, an imaging sensor (e.g., a charge coupled device or a CMOS imager), a lens, analog-to-digital circuitry, frame buffers, etc. Additional processing, conditioning, encoding, and/or compression of signals representing captured images may be performed by the general-purpose processor 330 and/or the DSP 331. Also or alternatively, the video processor 333 may perform conditioning, encoding, compression, and/or manipulation of signals representing captured images. The video processor 333 may decode/decompress stored image data for presentation on a display device (not shown), e.g., of the user interface 316.

The position device (PD) 319 may be configured to determine a position of the UE 300, motion of the UE 300, and/or relative position of the UE 300, and/or time. For example, the PD 319 may communicate with, and/or include some or all of, the SPS receiver 317 and the wireless transceiver 340. The PD 319 may work in conjunction with the processor 310 and the memory 311 as appropriate to perform at least a portion of one or more positioning methods, although the description herein may refer only to the PD 319 of the processor 310 being configured to perform, or performing, in accordance with the positioning method(s). The PD 319 may also or alternatively be configured to determine a location of the UE 300 using terrestrial-based signals (e.g., at least some of the signals 348) for trilateration/multilateration, for assistance with obtaining and using the SPS signals 360, or both. The PD 319 may be configured to use one or more other techniques (e.g., relying on the UE's self-reported location (e.g., part of the UE's position beacon)) for determining the location of the UE 300, and may use a combination of techniques (e.g., SPS and terrestrial positioning signals) to determine the location of the UE 300. The PD 319 may include one or more of the sensors 313 (e.g., gyroscope(s), accelerometer(s), magnetometer(s), etc.) that may sense orientation and/or motion of the UE 300 and provide indications thereof that the processor 310 (e.g., the processor 330 and/or the DSP 331) may be configured to use to determine motion (e.g., a velocity vector and/or an acceleration vector) of the UE 300. The PD 319 may be configured receive angle measurements and provide an angle error based on the determined position. The PD 319 may be used for calibration of a positioning session, such as described above with the generation of angle measurements or angle errors for known UE locations.

The memory 311 may store software 312 that contains executable program code or software instructions that when executed by the processor 310 may cause the processor 310 to operate as a special purpose computer programmed to perform the functions disclosed herein. As illustrated, the memory 311 may include one or more components or modules that may be implemented by the processor 310 to perform the disclosed functions. While the components or modules are illustrated as software 312 in memory 311 that is executable by the processor 310, it should be understood that the components or modules may be stored in another computer readable medium or may be dedicated hardware either in the processor 310 or off the processor. A number of software modules and data tables may reside in the memory 311 and be utilized by the processor 310 in order to manage both communications and the functionality described herein. It should be appreciated that the organization of the contents of the memory 311 as shown is merely exemplary, and as such the functionality of the modules and/or data structures may be combined, separated, and/or be structured in different ways depending upon the implementation.

The memory 311, for example, may include a positioning session module 372 that when implemented by the one or more processors 310 configures the one or more processors 310 to engage in a session to be used for generating one or more angle measurements (or other types of measurements) and generating an AEG report from the one or more angle measurements, as described herein. The positioning session module 372 may also be used to configure the subsets of antenna components for receiving one or more reference signals. While the positioning session module 372 is depicted as being software included in memory 311, the positioning session module 372 may be a hardware module, a software module, or a combination of hardware and software. For example, the module may include one or more application specific integrated circuits (ASICs), executable code, or a combination of both.

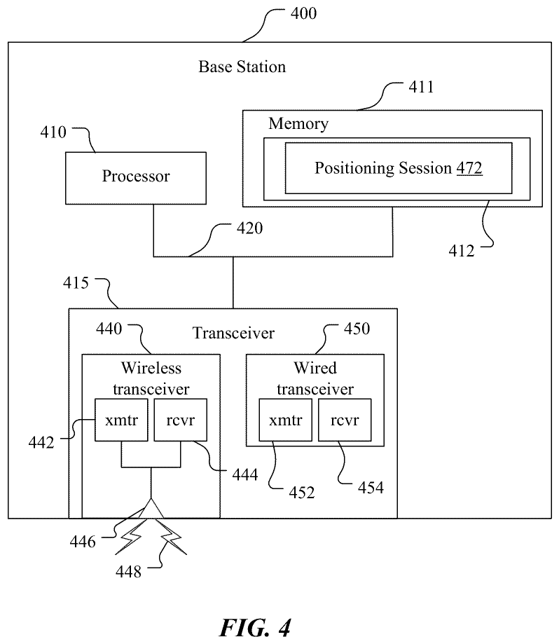

FIG. 4 illustrates a base station 400, which is an example of the base station 102, capable of supporting positioning services in a wireless network (such as wireless network 100). The base station 400 includes a computing platform including at least one processor 410, a memory 411 including software (SW) 412, and a transceiver 415. The processor 410, the memory 411, and the transceiver 415 may be communicatively coupled to each other by a bus 420 (which may be configured, e.g., for optical and/or electrical communication). One or more of the shown apparatus may be omitted from the base station 400, or the base station 400 may include one or more apparatus not shown. The processor 410 may include one or more intelligent hardware devices, e.g., a central processing unit (CPU), a microcontroller, an application specific integrated circuit (ASIC), etc. The processor 410 may comprise multiple processors (e.g., including one or more of an application processor, a DSP, a modem processor, a video processor, and/or a sensor processor, similar to that shown in FIG. 3). The memory 411 is a non-transitory storage medium that may include random access memory (RAM)), flash memory, disc memory, and/or read-only memory (ROM), etc. The memory 411 stores the software 412 which may be processor-readable, processor-executable software code containing instructions that are configured to, when executed, cause the processor 410 to operate as a special purpose computer programmed to perform the various functions described herein. Alternatively, the software 412 may not be directly executable by the processor 410 but may be configured to cause the processor 410, e.g., when compiled and executed, to operate as a special purpose computer to perform the various functions described herein. The description may refer only to the processor 410 performing a function, but this includes other implementations such as where the processor 410 executes software and/or firmware. The description may refer to the processor 410 performing a function as shorthand for one or more of the processors contained in the processor 410 performing the function. The description may refer to the base station 400 performing a function as shorthand for one or more appropriate components of the base station 400 performing the function. The processor 410 may include a memory with stored instructions in addition to and/or instead of the memory 411.

The transceiver 415 may include a wireless transceiver 440 and a wired transceiver 450 configured to communicate with other devices through wireless connections and wired connections, respectively. For example, the wireless transceiver 440 may include a transmitter 442 and receiver 444 coupled to one or more antennas 446 for transmitting and/or receiving (e.g., on one or more uplink channels and/or one or more downlink channels) wireless signals 448 and transducing signals from the wireless signals 448 to wired (e.g., electrical and/or optical) signals and from wired (e.g., electrical and/or optical) signals to the wireless signals 448. The antenna 446 is one or more antenna arrays capable of beam forming and transmitting and receiving beams, including beams used in transmitting or receiving signals (including PRSs) for positioning services. Also or alternatively, signals may be transmitted omnidirectionally. The transmitter 442 may include multiple transmitters that may be discrete components or combined/integrated components, and/or the receiver 444 may include multiple receivers that may be discrete components or combined/integrated components. The wireless transceiver 440 may be configured to communicate signals (e.g., with the UE 300, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 6GPP LTE-V2X (PC5), IEEE 802.11 (including IEEE 802.11p), WiFi, WiFi Direct (WiFi-D), Bluetooth®, Zigbee etc. The wired transceiver 450 may include a transmitter 452 and a receiver 454 configured for wired communication, e.g., to send communications to, and receive communications from, the location server 172. The transmitter 452 may include multiple transmitters that may be discrete components or combined/integrated components, and/or the receiver 454 may include multiple receivers that may be discrete components or combined/integrated components. The wired transceiver 450 may be configured, e.g., for optical communication and/or electrical communication.

The antennas 446 may include one or more antenna arrays. An antenna array may be capable of transmit beamforming or receive beamforming, e.g., by increasing the gain setting and/or adjust the phase setting of an array of antennas in a particular direction to amplify (e.g., to increase the gain level of) the RF signals received from that direction. The antennas 446 may further include a plurality of antenna panels, wherein each antenna panel is capable of beamforming. The antennas 446 are capable of adaptation, e.g., selection of one or more antennas for controlling receiving transmitted beams from a UE. A reduced number of beams or a single beam, for example, may be selected for reception of a wide angle beam, e.g., to reduce power consumption, while an increased number of antennas in an antenna array may be selected when the transmit beam is relatively narrow. In another example, different antennas may be selected for reception of a reference signal from different angles relative to the base station 400. Instead of controlling each antenna of the antenna array individually, an antenna array may include a plurality of subarrays, with each subarray capable of being controlled independently. Alternatively, the antennas 446 may include a plurality of independently controlled antennas. As used herein for the base station 400, an antenna system including a plurality of antenna components may include one or more of the antennas 446, one or more components of the receiver 444, other components of the wireless transceiver 440 not shown (such as power supplies or rails), or other components of the base station 400 that may impact an angle error for DL AoA based UE positioning.

The configuration of the base station 400 shown in FIG. 4 is an example and not limiting of the disclosure, including the claims, and other configurations may be used. For example, the description herein discusses that the base station 400 is configured to perform or performs several functions, but one or more of these functions may be performed by the location server 172 and/or the UE 300.

The memory 411 may store software 412 that contains executable program code or software instructions that when executed by the processor 410 may cause the processor 410 to operate as a special purpose computer programmed to perform the functions disclosed herein. As illustrated, the memory 411 may include one or more components or modules that may be implemented by the processor 410 to perform the disclosed functions. While the components or modules are illustrated as software 412 in memory 411 that is executable by the processor 410, it should be understood that the components or modules may be stored in another computer readable medium or may be dedicated hardware either in the processor 410 or off the processor. A number of software modules and data tables may reside in the memory 411 and be utilized by the processor 410 in order to manage both communications and the functionality described herein. It should be appreciated that the organization of the contents of the memory 411 as shown is merely exemplary, and as such the functionality of the modules and/or data structures may be combined, separated, and/or be structured in different ways depending upon the implementation.

The memory 411, for example, may include a positioning session module 472 that when implemented by the processor 410 configures the processor 410 to engage in a session to be used for generating one or more angle measurements (or other types of measurements) and generating an AEG report from the one or more angle measurements, as described herein. The positioning session module 472 may also be used to configure the subsets of antenna components for receiving one or more reference signals. While the positioning session module 472 is depicted as being software included in memory 411, the positioning session module 472 may be a hardware module, a software module, or a combination of hardware and software. For example, the module may include one or more application specific integrated circuits (ASICs), executable code, or a combination of both.

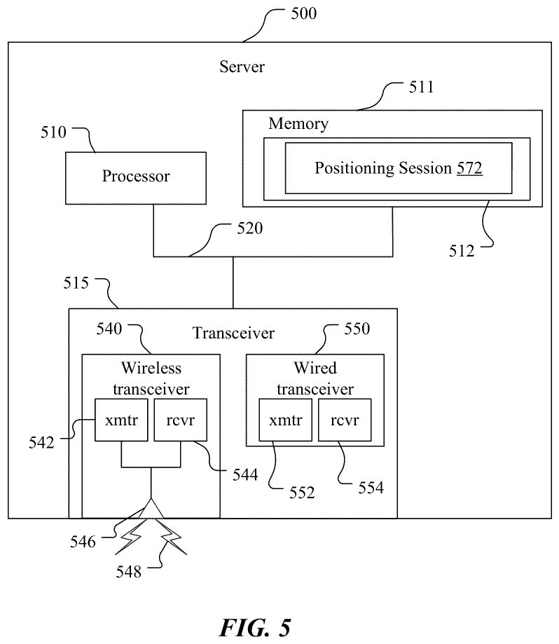

FIG. 5 shows a server 500, which is an example of the location server 172 capable of supporting positioning services in a wireless network (such as wireless network 100). The server 500 includes a computing platform including at least one processor 510, memory 511 including software (SW) 512, and a transceiver 515. The processor 510, the memory 511, and the transceiver 515 may be communicatively coupled to each other by a bus 520 (which may be configured, e.g., for optical and/or electrical communication). One or more of the shown apparatus (e.g., a wireless interface) may be omitted from the server 500. The processor 510 may include one or more intelligent hardware devices, e.g., a central processing unit (CPU), a microcontroller, an application specific integrated circuit (ASIC), etc. The processor 510 may comprise multiple processors (e.g., including at least one of an application processor, a DSP, a modem processor, a video processor, and/or a sensor processor, similar to that shown in FIG. 5). The memory 511 is a non-transitory storage medium that may include random access memory (RAM)), flash memory, disc memory, and/or read-only memory (ROM), etc. The memory 511 stores the software 512 which may be processor-readable, processor-executable software code containing instructions that are configured to, when executed, cause the processor 510 to operate as a special purpose computer programmed to perform the various functions described herein. Alternatively, the software 512 may not be directly executable by the processor 510 but may be configured to cause the processor 510, e.g., when compiled and executed, to operate as a special purpose computer to perform the various functions described herein. The description may refer only to the processor 510 performing a function, but this includes other implementations such as where the processor 510 executes software and/or firmware. The description may refer to the processor 510 performing a function as shorthand for one or more of the processors contained in the processor 510 performing the function. The description may refer to the server 500 performing a function as shorthand for one or more appropriate components of the server 500 performing the function. The processor 510 may include a memory with stored instructions in addition to and/or instead of the memory 511.

The transceiver 515 may include one or both of a wireless transceiver 540 or a wired transceiver 550 configured to communicate with other devices through wireless connections and wired connections, respectively. For example, the wireless transceiver 540 may include a transmitter 542 and receiver 544 coupled to one or more antennas 546 for transmitting (e.g., on one or more downlink channels) and/or receiving (e.g., on one or more uplink channels) wireless signals 548 and transducing signals from the wireless signals 548 to wired (e.g., electrical and/or optical) signals and from wired (e.g., electrical and/or optical) signals to the wireless signals 548. Thus, the transmitter 542 may include multiple transmitters that may be discrete components or combined/integrated components, and/or the receiver 544 may include multiple receivers that may be discrete components or combined/integrated components. The wireless transceiver 540 may be configured to communicate signals (e.g., with the base station 400 (such as a gNB), one or more other base stations, the UE 300, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 6GPP LTE-V2X (PC5), IEEE 802.11 (including IEEE 802.11p), WiFi, WiFi Direct (WiFi-D), Bluetooth®, Zigbee etc. The wired transceiver 550 may include a transmitter 552 and a receiver 554 configured for wired communication. The transmitter 552 may include multiple transmitters that may be discrete components or combined/integrated components, and/or the receiver 554 may include multiple receivers that may be discrete components or combined/integrated components. The wired transceiver 550 may be configured, e.g., for optical communication and/or electrical communication. The wired transceiver 550 (and/or wireless transceiver 540) may be used to communicate with one or more core network components (such as core network 170). The server 500 may communicate with a base station 400 via the core network 170 (such as to receive one or more AEG reports, to provide an indication of which antenna components are to be used to receive a reference signal, to provide signals for configuring components to generate a reference signal using LPP, or to provide other signals for operations of a wireless network).

The configuration of the server 500 shown in FIG. 5 is an example and not limiting of the disclosure, including the claims, and other configurations may be used. For example, the wireless transceiver 540 may be omitted. Also or alternatively, the description herein discusses that the server 500 is configured to perform or performs several functions, but one or more of these functions may be performed by a base station 400 and/or a UE 300.

The memory 511 may store software 512 that contains executable program code or software instructions that when executed by the processor 510 may cause the processor 510 to operate as a special purpose computer programmed to perform the functions disclosed herein. As illustrated, the memory 511 may include one or more components or modules that may be implemented by the processor 510 to perform the disclosed functions. While the components or modules are illustrated as software 512 in memory 511 that is executable by the processor 510, it should be understood that the components or modules may be stored in another computer readable medium or may be dedicated hardware either in the processor 510 or off the processor. A number of software modules and data tables may reside in the memory 511 and be utilized by the processor 510 in order to manage both communications and the functionality described herein. It should be appreciated that the organization of the contents of the memory 511 as shown is merely exemplary, and as such the functionality of the modules and/or data structures may be combined, separated, and/or be structured in different ways depending upon the implementation.

The memory 511, for example, may include positioning session module 572 that when implemented by the processor 510 configures the processor 510 to engage in a positioning session, as discussed herein. The positioning session module 572 may be used to identify a positioning measurement in an AEG report to be used for positioning of a UE. For example, the positioning session module 572 may be used to identify an AEG identifier (ID) associated with an AEG of a measuring device to be used to receive a future reference signal. In some implementations, the server 500 may transmit the AEG ID to indicate to the measuring device which AEG is to be used. In another example, the identified positioning measurement may be used in determining a position of the UE in the wireless network, which may be used for navigation, configuring cell selection or handover, configuring beamforming at the UE or base station, or any other operations that may be impacted based on the location of the UE. While the positioning session module 572 is depicted as being software included in memory 511, the positioning session module 572 may be a hardware module, a software module, or a combination of hardware and software. For example, the module may include one or more application specific integrated circuits (ASICs), executable code, or a combination of both.

As noted above, for AoA based UE positioning, one or more PRS may be transmitted from a base station to a UE or one or more SRS may be transmitted from a UE to a base station (with an AoA and/or ZoA being measured for the received reference signal to indicate a direction of the UE from the base station). A distance between a base station and a UE may be based on a TOA, which may be used to determine an OTDOA, an RTT, an RSTD, or any other suitable measurements used to determine a distance of a UE from a base station for positioning. In some implementations, specific resources of a reference signal (such as a PRS or an SRS) may be used for determining a TOA or otherwise used to measure the distance between a UE and a base station. Specific resources of a reference signal may also be used for calculating an angle measurement to indicate a direction of the UE from the base station. A location of the UE with reference to the base station may be determined based on the direction of the UE from the base station and the distance of the UE from the base station.

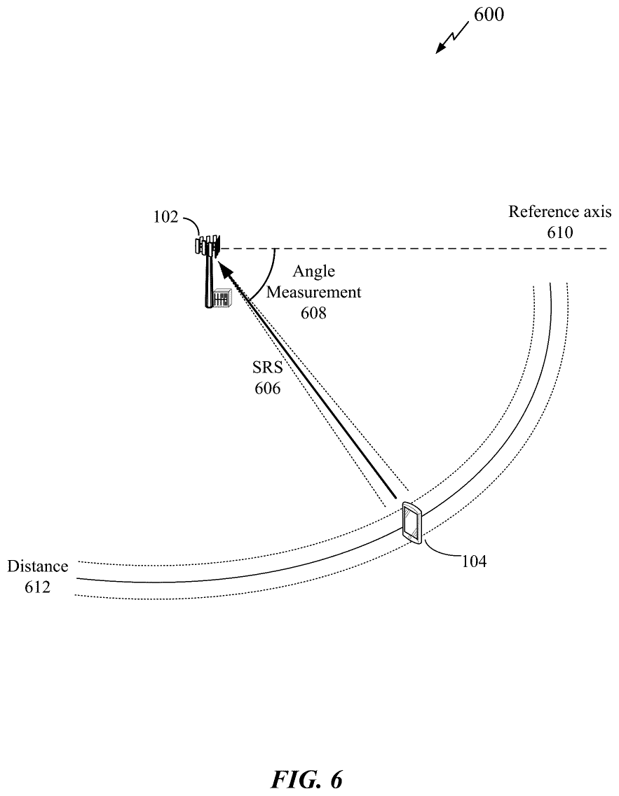

FIG. 6 illustrates an exemplary wireless communications system 600 implementing UE positioning using an UL AoA technique. In the example of FIG. 6, a base station 102 may generate an angle measurement 608 to be used in determining an estimate of the position of the UE 104 (which may be determined by the base station 102 or a location server 172). The UE 104 and base station 102 may communicate wirelessly, which may correspond to any combination of a UE 104 and base station 102 in FIG. 1, using RF signals and standardized protocols for the modulation of the RF signals and the exchange of information packets. By extracting different types of information from the exchanged RF signals, and utilizing the layout of the wireless communications system 600 (i.e., the base stations' locations, geometry, etc.), the base station 102 may determine the position of the UE 104, or assist in the determination of its position, in a predefined reference coordinate system. In an aspect, the position may be specified with reference to an angle measurement in a two-dimensional coordinate space (such as latitude and longitude); however, the aspects disclosed herein are not so limited, and may also be applicable to determining angle measurements using a three-dimensional coordinate system (such as latitude, longitude, and elevation) if the extra dimension is desired. Additionally, while FIG. 6 illustrates one UE 104 and one base station 102, as will be appreciated, there may be more UEs 104 and more or fewer base stations 102.

For UL AoA based UE positioning, the UE 104 transmits an SRS 606 to the base station 102. The base station 102 receives the SRS 606 and generates an angle measurement 608. For example, the base station 102 may use an antenna array to determine the direction from which the SRS 606 is received. A reference axis 610 (which may be any suitable direction, such as true north for two-dimensional angles or perpendicular to the azimuth for three-dimensional angles) may be compared to the direction from which the SRS 606 is received to compute the angle measurement 608. The angle measurement 608 may be one or both of an AoA or ZoA of the SRS 606. Because of potential tolerances in the antenna components for receiving the SRS 606, the SRS 606 (which is measured as being received along the solid line for SRS 606) may be received slightly askew from the measured direction (such as within the cone between the dashed lines from the UE 104 to the base station 102). The difference between the angle measurement 608 and the actual angle (based on the actual direction) may be the angle error.

In some implementations, the base station 102 may also determine the distance 612 or assist another device in determining the distance 612 (e.g., a location server 172 or a core network component). For example, the distance 612 may be based on RSTDs between reference signals from multiple sources or other TOA based measurements. In another example, the distance 612 may be determined using multiple angle measurements from different base stations receiving SRS 606 from the UE 104. Based on the known locations of the base stations and the multiple angle measurements, the distance 612 may be determined. Since the angle measurements may include some error, the distance 612 may include some error as depicted in FIG. 6. The position of the UE 104 may be indicated with reference to a base station 102 (referred to as a local position or location) or may be indicated in an absolute manner (such as per latitude and longitude (and optionally elevation), referred to as a global position or location). The operations for determining a position of a UE using UL AoA based UE positioning is similar to as described above with reference to DL AoA based UE positioning, except that the UE 104 receives PRS from one or more base stations and determines (or assists in determining) one or more angle measurements from the PRS.

As noted above, one or more antenna components receiving a reference signal may cause an error in the angle measurement to be generated. For example, a subarray may be associated with a noise that is introduced to the received signal that causes an error in the angle measurement. In another example, a direction of an antenna may cause noise in the received signal that causes an error in the angle measurement. As such, which antenna components are to be used by a device to receive a reference signal may be based on the direction of the source of the reference signal in order to reduce the angle error associated with the angle measurement.

As described herein, one or more devices (such as a base station or a UE) may perform operations to receive reference signals using different subsets of antenna components (AEGs), generating angle measurements from the reference signals and generating an AEG report based on the angle measurements (which may be used to identify the AEG to be used to receive a future reference signal). Also as described herein, one or more devices (such as a location server) may perform operations to receive one or more AEG reports generated by one or more measuring devices and identifying a positioning measurement in an AEG report to be used, such as indicating an AEG to be used for receiving a future reference signal, determining a location of the UE in the wireless network, etc.

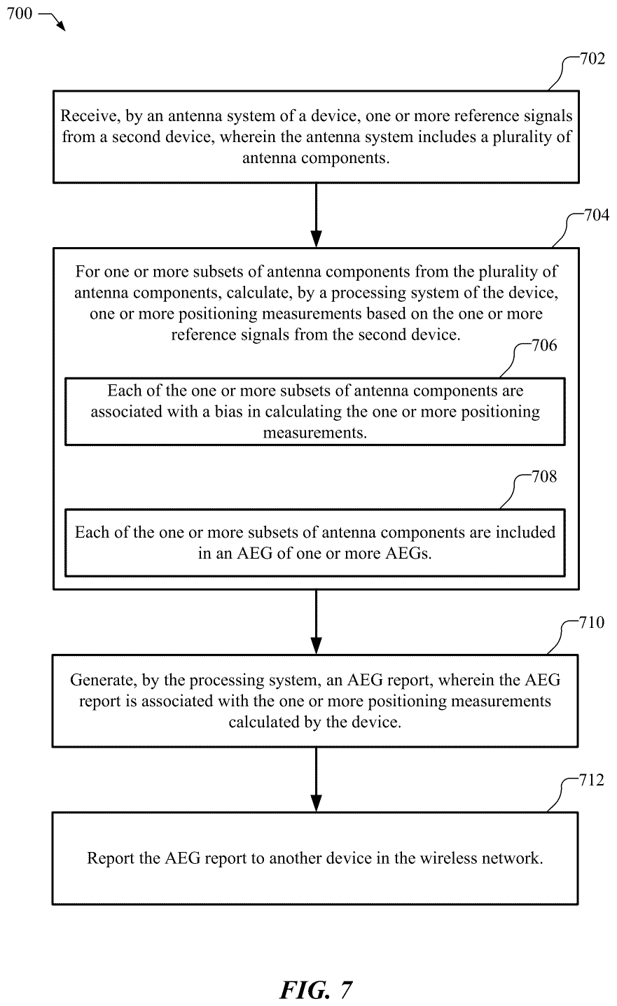

FIG. 7 shows a flowchart for an exemplary method 700 for supporting positioning of a UE in a wireless network. The exemplary method 700 may be performed by any suitable device in a wireless network, such as a UE 104 or a base station 102 shown in FIG. 1, in a manner consistent with disclosed implementations. For example, the method 700 may be performed by a UE 104 for DL AoA based UE positioning or by a base station 102 for UL AoA based UE positioning. A device that may perform one or more operations in method 700 may include an antenna system including a plurality of antenna components, at least one transceiver (such as one or more wireless transceivers and/or one or more wired transceivers), at least one memory, and at least one processor coupled to the at least one transceiver and the at least one memory. Referring to the UE 300 as an example device, the antenna system may include antennas 346 and/or other suitable components, the at least one transceiver may include the transceiver 315 or the wireless transceiver 340, the at least one memory may include the memory 311, and the at least one processor may include one or more of the processor 310, one or more of processors 330-334, or the position device 319. Referring to the base station 400 as an example device, the antenna system may include antennas 446 and/or other suitable components, the at least one transceiver may include all or a portion of the transceiver 415, the at least one memory may include the memory 411, and the at least one processor may include the processor 410.

At block 702, a device receives, by an antenna system of the device, one or more reference signals from a second device. The antenna system includes a plurality of antenna components. For example, the antenna system including the antennas 446 of a base station 400 may include one or more antenna arrays, and an antenna array may include a plurality of subarrays. For a UE 300, the antenna system including the antennas 346 may include an antenna array, and the antenna array may include a plurality of subarrays. In another example, the antenna system may include a plurality of antennas 346 of the UE 300 or a plurality of antennas 446 of the base station 400. The plurality of antenna components may include the plurality of antennas (such as each antenna being an antenna component). As noted above, device components other than the antennas may be antenna components of the antenna system, such as an oscillator used for driving an antenna or subarray, a power rail for an antenna or subarray, or other components for controlling or operating an antenna or subarray. Means for receiving one or more reference signals may include the antenna system and optionally at least one transceiver of the device.

If the device is a base station, the second device may be a UE, and the one or more reference signals may be one or more SRSs for UL AoA based UE positioning. If the device is a UE, the second device may be a base station, and the one or more reference signals may be one or more PRSs for DL AoA based UE positioning. In some implementations, the wireless network including the UE and base station is a cellular network. In some implementations, the base station is a gNB for either of UL AoA based UE positioning or DL AoA based UE positioning.

A subset of antenna components may be capable of receiving a reference signal from the second device. For example, if the antenna system includes a plurality of antennas, each of the antennas capable of listening in the direction of the second device may receive the reference signal. In another example, if the antenna system includes an antenna array, a subset of subarrays may be configured to receive the reference signal (such as by configuring the subset of subarrays as a phased array for receive beamforming to receive the reference signal from a specific direction). As noted above, each subset of subarrays that may be capable of receiving a reference signal may be referred to as or included in an AEG. Each antenna component may be associated with an error (also referred to as a bias) that may be introduced to an angle measurement. As such, each AEG is associated with a bias in calculating an angle measurement.

In some implementations of receiving one or more reference signals, the device receives a reference signal using more than a single subset of antenna components. For example, all of the antennas capable of receiving a reference signal may be used to receive the reference signal. As such, multiple AEGs may be used to receive the same reference signal.

In some implementations of receiving one or more reference signals, the device receives several instances of a reference signal over time. For example, a UE may periodically transmit an SRS, or a base station may periodically transmit a PRS. A first AEG may be used to receive a first instance of the reference signal, a second AEG may be used to receive a second instance of the reference signal, and so on. For example, if a plurality of antennas are used to receive the reference signal, a first subset of antennas may be configured to receive the first instance, a second subset of antennas may be configured to receive the second instance, and so on. In another example, if an antenna array is used to receive the reference signal, a first subset of subarrays may be configured to receive a first instance, a second subset of subarrays may be configured to receive a second instance, and so on. To note, the subsets of antenna components may overlap or may be mutually exclusive. As such, an antenna component may be included in any number of AEGs (including zero if the antenna component is not to be used for positioning).

Regarding subsets of antenna components of a device, the subsets of antenna components may be predefined, such as by a device manufacturer, by a user, or otherwise indicated such that a predefined number of subsets of antenna components may potentially be used by the device. In some implementations, the final subsets of antenna components that are to be used by a device may be determined during calibration in which various potential subsets of antenna components are used to receive a reference signal from which an angle measurement (and possibly an angle error) is generated and compared to determine the final subsets of antenna components to be used during operation of the device. In some implementations, the device may be limited to a maximum number of subsets of antenna components or AEGs in general.

At block 704, for one or more subsets of antenna components from the plurality of antenna components, the device calculates, by a processing system of the device, one or more positioning measurements based on the one or more reference signals from the second device. For example, for each AEG used to receive a reference signal, the output of each subset of components that receives the reference signal is used to generate a UE positioning measurement. In this manner, at least one UE positioning measurement may be generated for each instance of a reference signal received, but more than one UE positioning measurement may be generated if multiple subsets of antenna components are used to receive the reference signal. As noted above, each of the one or more subsets of antenna components are associated with a bias in calculating the one or more positioning measurements (706), and each of the one or more subsets of antenna components are included in an AEG of one or more AEGs (708).

As used herein, a UE positioning measurement may be any element that may be included in an AEG report or otherwise used for UE positioning. Example UE positioning measurements include, e.g., an angle measurement, an angle error or bias, or other types of measurements or measurement errors. For example, the one or more positioning measurements based on the one or more reference signals may include one or more of an AoA of the one or more reference signals at the device or a ZoA of the one or more reference signals at the device. In another example, a UE positioning measurement based on a reference signal may include an angle error determined for one or more of the AoA or ZoA. To note, AoA as used herein may refer to a two dimensional angle (without ZoA) or a three dimensional angle (including ZoA). In some implementations, each UE positioning measurement is associated with an AEG ID that is associated with an AEG to receive the reference signal used for generating the UE positioning measurement. For example, an AEG ID may be used to identify the subset of antenna components used or to be used to receive a reference signal.

While an AEG is described above as being or including a subset of antenna components, an AEG may also include configurations of the antenna components or other factors affecting a UE positioning measurement. For example, an AEG may be based on a time when a reference signal is to be received, which reference signal or what type of reference signal is to be received, a configuration of one or more subarrays to receive a reference signal, etc. As such, an AEG ID may identify the subset of antenna components to receive a reference signal as well as which reference signal is to be received, the configuration of the antenna components, etc. For example, a first UE positioning measurement calculated based on a first reference signal received at a first time by a first subset of antenna components may be associated with a first AEG ID, and a second UE positioning measurement calculated based on a second reference signal received at a second time by a second subset of antenna components may be associated with a second AEG ID. The first AEG ID may differ from the second AEG ID based on one or more of: the first reference signal differing from the second reference signal; the first time differing from the second time; or the first subset of antenna components differing from the second subset of antenna components. The AEG ID may be in any suitable format, such as a vector of values, with, e.g., a first value used to identify the subset of antenna components, a second value used to identify which instance of a reference signal is to be received, etc.

At block 710, the device generates, by the processing system, an AEG report, with the AEG report associated with the one or more positioning measurements calculated by the device. At block 712, the device reports the AEG report to another device in the wireless network. If the device is a base station, the other device to receive the AEG report may be a location server, a core network component, or another component to relay the AEG report to the location server. If the device is a UE, the other device to receive the AEG report may be the location server, a base station, or another UE to relay the AEG report to the location server or a base station that uses the AEG report.

In some implementations, an AEG report may indicate the AEG that the device determines to use for receiving a reference signal for UE positioning. For example, the device may be capable of generating angle measurements from the one or more reference signals, determining an angle error for each angle measurement, and selecting an AEG based on the angle errors (such as the AEG having the smallest angle error). The AEG may include one or more of the subset of antenna components to be used to receive a reference signal, the reference signal or instance of the reference signal to be received using the subset of antenna components, or a time that the reference signal is to be received. The time of reception and which reference signal is to be received may be based on a known periodicity of the reference signal, which may be setup using configurations provided by a location server using LPP messaging or other suitable means. If the device determines the AEG to be used, the AEG report may include an AEG ID associated with the determined AEG. In some implementations, AEG IDs or values for constructing AEG IDs (such as values associated with the subsets of antenna components) may be stored in a memory of the device and retrieved for inclusion into an AEG report.

In some implementations, the device may provide multiple positioning measurements for another device to discern which positioning measurement is to be used. For example, a location server or another network device (such as a base station if the device is a UE) may determine, based on the positioning measurements in an AEG report, the AEG (or one or more AEGs) to be used to receive a future reference signal. For example, a base station or a UE may calculate one or more angle measurements. The one or more angle measurements may be included in one or more AEG reports, and the location server (or other device) may use the one or more angle measurements in the one or more AEG reports to identify an AEG to be used for receiving a future reference signal by the base station or UE. As noted above, the AEG to be identified may be based on reducing the angle error in the angle measurements for a reference signal. An angle error may be based on the angle measurement, which may be known (such as during calibration) or may be assumed in comparing a plurality of angle measurements. If the angle errors are known, the location server may store an index of angle measurements and associated angle errors for different subsets of antenna components or AEGs (which may include the subsets of antenna components, the configurations of the antenna components, the reference signal to be received, and so on). The location server may look up the one or more angle measurements from the one or more AEG reports in the index to determine the associated angle errors, and the location server may select the AEG associated with the smallest angle error. In another example, the index may include an AEG ID associated with different angle measurements. For example, the index may include ranges of angle measurements, and each range of angle measurement may include an association to an AEG ID indicating a subset of antenna components to be used and/or other configuration information regarding receiving a reference signal. In some implementations, the angle error may be unknown to the location server. As such, the location server may determine an AEG (or determine a positioning measurement to be used for performing other types of operations) based on a statistical or machine learning model or other means without the angle errors being explicitly known.

In some implementations, an AEG report may include one or more angle errors determined by the device. For example, the device may include an index of angle measurements to angle errors (such as based on calibration using a reference device as described in more detail below). The device may generate the angle measurements and look up the associated angle errors in the index, and the device may include one or more angle errors in one or more AEG reports. The location server (or other device receiving the one or more AEG reports) may determine the positioning measurement to be used (such as to determine the AEG to be used by the device) based on the angle errors (such as the positioning measurement associated with the smallest angle error). In some implementations, the location server may indicate a plurality of preferrable AEGs based on the angle errors (or angle measurements) in the one or more AEG reports, and the device may select the AEG to be used.

The AEG report may be in any suitable format and provided in any suitable manner to another device. Communication of the AEG report and the formatting of the AEG report may be standardized (such as in the 3GPP set of standards) or may be proprietary. In some implementations, generating the AEG report includes including, in the AEG report, one or more UE positioning measurements calculated by the device. For example, the AEG report may include one or more angle measurements and/or one or more angle errors calculated by the device from the one or more reference signals. Each UE positioning measurement in the AEG report may be associated with an AEG ID (which may be generated or otherwise obtained by the device). In some implementations, generating the AEG report includes including each AEG ID associated with each of the one or more UE positioning measurements in the AEG report. The AEG IDs may be used to differentiate between different UE positioning measurements at the location server, may be used to identify the associated subset of antenna components used to receive a reference signal at the base station or UE that receives the one or more reference signals, may be used to identify the time at which the reference signal was received, may be used to identify which reference signal was received, etc.

In some implementations, including each AEG ID is based on an AEG report including more than one UE positioning measurement. For example, if a device is configured to include one UE positioning measurement per AEG report, the AEG ID may not be needed to differentiate between different angle measurements or angle errors. As such, generating the AEG report may include preventing including the AEG ID associated with a UE positioning measurement when the AEG report is to include only one UE positioning measurement. Not requiring the inclusion of an AEG ID in the AEG report may reduce the size of the AEG report and/or reduce the overhead in transmitting the AEG report.

In some implementations, a plurality of UE positioning measurements may be generated using a plurality of subsets of antenna components, and the UE positioning measurements may be the same. For example, an angle measurement from a first subset of antenna components may be the same as an angle measurement from a second subset of antenna components. As used herein, “same” refers to being within a tolerance of one another. For example, a first angle measurement and a second angle measurement may be considered the same, even if different in absolute terms, if the first and second angle measurements are within a predefined tolerance of each other (such as plus or minus one degree or another suitable tolerance). In some implementations, the tolerance may be based on a maximum error that may be associated with an angle measurement (such as two angle measurements being considered the same if two angle measurements are within a maximum angle error of each other). In some implementations, each of the UE positioning measurements may be reported in one or more AEG reports. In some implementations, one UE positioning measurement may be included in the one or more AEG reports as a representation of the plurality of UE positioning measurements that are the same. Sending only one UE positioning measurement may reduce the size of an AEG report and/or reduce the overhead in transmitting the AEG report. If the representative UE positioning measurement is the only UE positioning measurement in an AEG report, the AEG report may also not include an AEG ID associated with the UE positioning measurement. In some implementations, if multiple subsets of antenna components are used to receive one or more reference signals, the AEG ID not being included may imply that the UE positioning measurements calculated for the one or more reference signals received by various subsets of antenna components are the same. As such, different subsets of antenna components do not need to be differentiated if each subset of antenna components to receive a reference signal leads to the same UE positioning measurement (such as the same angle measurement). In this manner, multiple subsets of antenna components may be associated with the same AEG.

In some implementations, generating the AEG report may include, for each UE positioning measurement, including a timestamp of the reference signal used to calculate the UE positioning measurement in the AEG report. For example, if different instances of a reference signal is received at different times, the device may generate a time stamp of the time associated with each UE positioning measurement. The time stamp may be based on a time indicated in the reference signal, a known time of when the reference signal is to be received, a time based on a timer at the receiver of the device, or any other suitable means for indicating the time that the reference signal is received.

In some implementations, the AEG report including the one or more UE positioning measurements, the one or more AEG IDs, and/or the one or more time stamps may be included in one or more measurement reports that are transmitted to the other device (such as to be received by the location server). For example, the information may be in fields concatenated together and included as a payload in a frame of a measurement report message to the other device. As such, reporting the AEG report may include transmitting a main measurement report to a location server in the wireless network, with the main measurement report including at least a portion of the AEG report.

In some implementations, the AEG report may be transmitted in multiple measurement reports (such as a main measurement report and one or more secondary measurement reports). For example, the AEG report may be too large to fit into a fixed size measurement report, which may be defined in a standard or otherwise predefined. As such, reporting the AEG report may include transmitting one or more secondary measurement reports in addition to a main measurement report to a location server in the wireless network, wherein the one or more secondary measurement reports include at least a portion of the AEG report. The main and secondary measurement reports may include the same one or more AEG IDs to indicate that the measurement reports are associated with each other. In some implementations, the main measurement report may include the UE positioning measurements, and the one or more secondary measurement reports may include other information associated with the UE positioning measurements (such as a time stamp). In some implementations, each measurement report may include a single UE positioning measurement and its associated information (such as a time stamp). Other formats of the measurement reports may be envisioned without deviating from the scope of the present disclosure.

The device determining when to generate and report an AEG report may be performed in any suitable manner. For example, a schedule of when the device is to report the AEG reports may be configured at the device (such as based on a schedule determined by the location server). The schedule may be based on a periodicity of a reference signal to be transmitted by the second device, the schedule may be based on times when the AEG to be used is to be reselected, or the schedule may be determined using any other suitable means. In addition or alternative to a device periodically generating and reporting an AEG report, reporting of an AEG report may be on demand. For example, the device may periodically generate an AEG report or the UE positioning measurements for an AEG report, but the device may not transmit the AEG report in one or more measurement reports unless requested (such as by the location server). In another example, the device may generate an AEG report and report the AEG report in one or more measurement reports upon receiving a request from another device (such as a request originating from the location server). Referring back to block 704 of method 700, calculating the UE positioning measurement for one or more subsets of antenna components may be in response to receiving the indication from the location server.

A request for an AEG report may include one or more AEG IDs indicating one or more AEGs to be used for receiving a reference signal (such as the subset of antenna components, the reference signal to be received, and/or the time when the reference signal is to be received). In receiving the request, the device may receive one or more AEG IDs in an indication from a location server of the wireless network. If reporting the AEG report is on demand for method 700, receiving a reference signal from the second device includes, for one or more AEG IDs, identifying a first subset of antenna components of the AEG corresponding to the AEG ID and receiving the reference signal from the second device using the first subset of antenna components. The device may also calculate a first UE positioning measurement based on the reference signal received by the first subset of antenna components, with the AEG report that is reported including the first UE positioning measurement.

If the request includes multiple AEG IDs, multiple AEG IDs may correspond to the same subset of antenna components (but different times to receive the reference signal or other configuration differences). If the multiple AEG IDs correspond to different subsets of antenna components, the device may select one AEG ID to be used to select the first subset of antenna components to receive a reference signal. Alternatively, the device may use different subsets of antenna components to receive the reference signal based on the different AEG IDs.

In some implementations, if the indication includes multiple AEG IDs, each of the AEG IDs in the indication from the location server may be required to be used by the device to calculate a UE positioning measurement. For example, for each AEG ID, the associated subset of antenna components may be configured to receive a reference signal at a specific time associated with the AEG ID. In another example, the AEG IDs may indicate different times for one or more subsets of antenna components to be used to receive a reference signal. As such, the device may generate a UE positioning measurement for each AEG ID. In some implementations, the indication from the location server includes an indication of time associated with a reference signal to be used in calculating a UE positioning measurement. For example, the location server may indicate the time at which the reference signal is to be received or otherwise to identify the reference signal or instance of a reference signal to be received by the device to calculate a UE positioning measurement. As noted above, the indication of time may be included in the AEG ID.

Before the location server requests an AEG report (with the request including one or more AEG IDs), the location server may need to determine if the device supports multiple AEGs. Some devices may not be able to use only a subset of antenna components (instead of all of the antenna components) to receive a reference signal or may otherwise not support multiple AEGs. For example, some devices may be unable to use multiple configurations of the antenna system or may be unable to generate AEG reports. In some implementations, the location server may provide an inquiry as to whether the device supports multiple AEGs. As such, the device may receive a request from the location server as to whether the device supports multiple AEGs. The request may be in any suitable form, such as being configured between the device and the location server or based on a standard. After receiving the request from the location server, the device may provide a response indicating whether the device supports multiple AEGs. In some implementations, the request may also include a request as to the number of AEGs that the device supports, and the response may also indicate the number of AEGs supported by the device. For example, the response may include a number of AEG IDs equal to the number of AEGs supported and that can be used to identify each AEG.

In some implementations, the request may request the number of measurement reports or the number of AEG reports the device supports or otherwise how the device reports the UE positioning measurements for different AEGs. If each measurement report is for one AEG, a response indicating the number of measurement reports may be used to indicate the number of AEGs supported. The request and response may be in any suitable form, such as the response indicating the number of UE positioning measurements to be included per measurement report, a format of the measurement report, or other indications of the device's capability to use multiple AEGs.

Referring back to blocks 702 and 704 of method 700, the AEGs to be used for receiving a reference signal and calculating a UE positioning measurement may be determined in any suitable manner. In some implementations, the AEGs to be used each time are predefined. For example, each subset of antenna components that may be used is predefined. When the device receives a request for an AEG report, the device may use each subset to receive a reference signal and generate a UE positioning measurement for each instance of the received reference signal. As such, the one or more AEG IDs indicated in the request from the location server may indicate the reference signal to be received or a time when the reference signal is to be received.

In some implementations, the AEGs to be used may be identified by the device in order to receive the one or more reference signals and calculate one or more UE positioning measurements. Before receiving the one or more reference signals at block 702, the device may identify the one or more AEGs to be used. To note, each AEG of the one or more AEGs includes at least one subset of antenna components from the plurality of antenna components associated with a same bias in calculating UE positioning measurements. For example, a first subset of antenna components may be associated with a first bias, and a second set of antenna components may be associated with a second bias. The AEGs including the one or more subsets of antenna components may be identified based on defined candidate subsets of antenna components or any suitable list of subsets that may be used by the device to receive a reference signal. Determining the AEGs to be used may be performed during calibration.

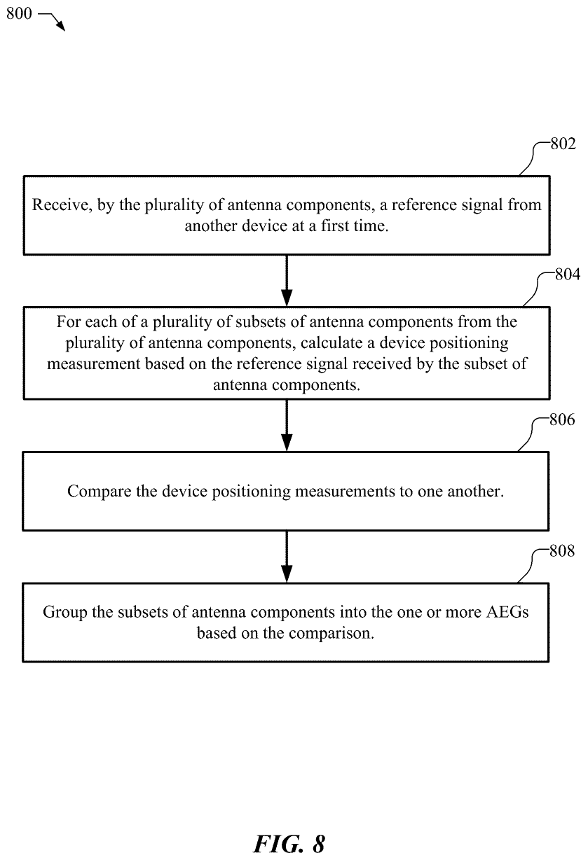

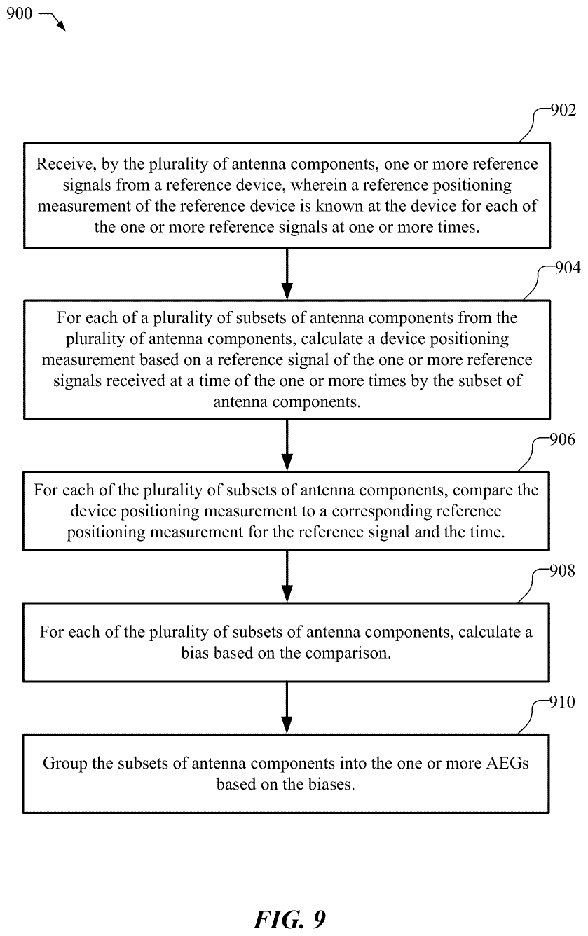

Calibration refers to a process during which the device identifies the AEGs to be used to receive one or more reference signals for generating one or more AEG reports. The identified AEGs may be the AEGs used to receive reference signals used for generating AEG reports as described above with reference to method 700 in FIG. 7. As noted above, calibration may include determining an angle error for different angle measurements and different antenna components. Identification of the AEGs may be based on the angle errors. To note, identifying AEGs may refer to exclusively identifying different subsets of antenna components to be used to receive a reference signal or may refer to identifying one or more of different subsets of antenna components, different configurations for one or more subsets of antenna components, a reference signal (such as a type of reference signal) to be received by one or more subsets of antenna components, or any other suitable information to be used to configure the device for receiving the one or more reference signals in block 702 of method 700 in FIG. 7. Calibration may be performed in two ways: based on real-time measurements from a single reference signal (described below with reference to FIG. 8) or based on use of a reference device to provide a reference location of the device when transmitting the reference signal (described below with reference to FIG. 9).

For real-time measurements of a reference signal between a UE and a base station, the location of the UE with reference to the base station is unknown (with the base station, UE, and/or location server of the wireless network to determine the location of the UE in the wireless network using one or more positioning techniques, such as AoA based UE positioning techniques described herein). With the UE location with reference to the base station being unknown, the actual angle measurement (which may include one or both of an AoA or a ZoA) for a received reference signal (which may be a UL SRS or a DL PRS) is unknown. However, if two different antenna components (or two subsets of antenna components) are able to receive the same reference signal at the same time, the actual angle to be measured (also referred to as an actual angle measurement) is the same for each of the two antenna components receiving the same reference signal. For example, for an antenna array, if a first subarray receives a first reference signal at a first time and a second subarray also receives the first reference signal at the first time, the AoA of the first reference signal should be the same for both the first subarray and the second subarray. As such, if the bias of the first subarray is the same as the bias of the second subarray, an angle measurement for the first subarray and an angle measurement for the second sub array receiving the same reference signal should be the same. Any divergence in the angle measurements between the two subarrays indicates a divergence in the bias between the two subarrays. Antenna components having the same bias (thus yielding the same angle measurement) may be grouped together as part of a same AEG.

FIG. 8 shows a flowchart for an exemplary method for identifying one or more AEGs for use by a device to receive one or more reference signals (such as in block 702 of FIG. 7). The exemplary method 800 may be performed by any suitable device in a wireless network, such as a UE 104 or base station 102 shown in FIG. 1, in a manner consistent with disclosed implementations. For example, the method 800 may be performed by a UE 104 for DL AoA based UE positioning or by a base station 102 for UL AoA based UE positioning. A device that may perform one or more operations in method 800 may include an antenna system including a plurality of antenna components, at least one transceiver (such as one or more wireless transceivers and/or one or more wired transceivers), at least one memory, and at least one processor coupled to the at least one transceiver and the at least one memory. Referring to the UE 300 as an example device, the antenna system may include antennas 346 and/or other suitable components, the at least one transceiver may include the transceiver 315 or the wireless transceiver 340, the at least one memory may include the memory 311, and the at least one processor may include one or more of the processor 310, one or more of processors 330-334, or the position device 319. Referring to the base station 400 as an example device, the antenna system may include antennas 446 and/or other suitable components, the at least one transceiver may include all or a portion of the transceiver 415, the at least one memory may include the memory 411, and the at least one processor may include the processor 410.

At block 802, the device receives, by the plurality of antenna components of the antenna system, a reference signal from another device at a first time. In other words, the plurality of antenna components receives the same reference signal at the same time. For example, for a plurality of antennas, each antenna able to receive the reference signal may receive the reference signal at the first time. For an antenna array, each subset of subarrays able to receive the reference signal may receive the reference signal at the first time. As noted above, “same” may refer to two objects being within a tolerance of each other. For example, a plurality of antennas may be spatially separated from one another such that the same reference signal reaches each antenna a miniscule amount of time different than the other antennas. However, such miniscule amounts of time is considered to be within the tolerance such the reference signal is considered to be received by each antenna at the same time.

How the antenna system is configured to receive the reference signal may be in any suitable manner. For example, an antenna array may be conceptually partitioned into a plurality of subsets of subarrays configured to receive the reference signal. Each subset may include one or multiple subarrays. A subset of antenna components may include one or more antennas (or subarrays of an antenna array) and logic to drive the one or more antennas or subarrays (such as an oscillator and power rail). As noted above, candidate subsets of antenna components may already be defined for the device, with calibration used to determine which candidate subsets are to be used in the future.

At block 804, for each of a plurality of subsets of antenna components from the plurality of antenna components, the device calculates a device positioning measurement based on the reference signal received by the subset of antenna components. In some implementations, the device uses each of the plurality of subsets of antenna components to receive a reference signal at the same time, and the device calculates an angle measurement (such as an AoA and/or a ZoA) for each instance of the reference signal being received by the plurality of subsets of antenna components.

At block 806, the device compares the device positioning measurements to one another. In some implementations, the device compares the angle measurements. If a first angle measurement associated with a first subset of antenna components is the same as a second angle measurement associated with a second subset of antenna components (such as being within a tolerance of each other), the first subset of antenna components and the second subset of antenna components may be considered to have the same bias for the angle measurement. If the first angle measurement and the second angle measurement are different (such as diverging by more than the tolerance), the first subset of antenna components and the second subset of antenna components may be considered to have the same bias for the angle measurement.

At block 808, the device groups the subsets of antenna components into the one or more AEGs based on the comparison. The one or more AEGs may be the AEGs identified for use for method 700 in FIG. 7 to receive one or more reference signals. In some implementations, the device positioning measurements calculated for the subsets of antenna components of a same AEG are the same. For example, if an angle measurement is the same between different subsets of antenna components, the device may group the different subsets of antenna components into one AEG. When the AEG is to be used to receive a future reference signal, all of the antenna components of the AEG may be used to receive the reference signal. For example, if two separate antennas are grouped together into an AEG, each antenna may be used to receive the reference signal. In another example, if two subsets of subarrays configured as phased arrays are grouped together into an AEG, the subarrays of the two subsets may be configured together as one phased array to receive the reference signal. Using all antenna components to receive the reference signal may allow for redundancy so that if a component fails or has issues receiving the reference signal, the reference signal is still received by other antenna components for the AEG. Alternatively, when the AEG is to be used to receive a future reference signal, only a portion of the antenna components of the AEG may be used to receive the reference signal. For example, if two subsets of antenna components are grouped into the same AEG, only one subset of antenna components (which may be a representative subset of antenna components for the AEG) may be used to receive the future reference signal. Using only a portion of the antenna components to receive the reference signal may allow for lower power or processing resource consumption as not all components are required to be operated.

To note, even if the bias is the same for a device positioning measurement (e.g., an angle measurement) for two or more subsets of antenna components, the bias may be considered to be the same for only the specific device positioning measurement or only for a range of device positioning measurements including the device positioning measurement. For example, if the position of the UE with reference to the base station changes such that an angle measurement is to change, the biases for subsets of antenna components considered to be the same for a first UE position may diverge from each other for a second UE position. In some implementations, the method 800 may be performed a plurality of times for a plurality of different UE positions relative to the base station. The device or another device in the wireless network (such as a location server) may store a list of AEGs associated with different device positioning measurements or ranges of device positioning measurements. Each time method 800 is performed for a new UE position, the list may be updated regarding the new position (such as by populating the list with new AEGs for the position). In some implementations, method 800 may also be performed for a same UE position in order to update the list (such as updating the antenna components in one or more AEGs) regarding the corresponding UE position. In some other implementations, method 800 may be performed before each time an AEG report is to be generated.

In addition or alternative to using real-time measurements for calibration, a reference device with a known location to transmit a reference signal may be used for calibration. In some implementations, a reference device may include a GNSS or GPS receiver and/or other sensors that may be used to determine the geographic location of the reference device. For example, for UL AoA based UE positioning, the UE 300 as a reference device includes the SPS receiver 317 and PD 319 that may be used to determine the UE's geographic location. A barometric pressure sensor of the sensors 313 may also be used to determine the UE's elevation (such as with reference to sea level). If the geographic location of the base station is known (such as for a fixed position base station or the base station including a GNSS or GPS receiver), the geographic locations of the base station and the reference device at the time when the reference signal is transmitted from the reference device to the base station may be compared to determine the position of the reference device relative to the base station. For DL AoA based UE positioning, another UE or other suitable mobile device may act as a reference device to the UE. As noted above for UL AoA based UE positioning, the reference device may include one or more receivers and/or sensors to be used to determine the location of the reference device when transmitting a reference signal. The reference device may be configured to imitate a base station transmitting a PRS at one or more positions around the UE. While the UE may not have a fixed position, the UE may include one or more receivers and/or sensors to determine the location of the UE (such as the SPS receiver 317, PD 319, and/or a barometric pressure sensor of the sensors 313 of a UE 300). Similar to as described above for UL AoA based UE positioning, the geographic locations of the UE and the reference device at the time when the reference signal is transmitted from the reference device to the UE may be compared to determine the position of the UE relative to the reference device.

In addition to transmitting a reference signal (such as an SRS or PRS) to a measuring device (such as a base station or a UE), the reference device may also transmit information regarding its geographical location (such as coordinates) to the measuring device. For example, the reference signal from the reference device to be used for calibration may include a payload indicating a location of the reference device. However, other implementations of obtaining the location of the reference device may be used. For example, the reference device may transmit a separate message via any suitable link between the measuring device and the reference device, a user may manually enter a location of the reference device via a user interface of the measuring device, or the reference device may be placed at a predefined location for sending a reference signal. The measuring device may determine the actual angle or other measurement between the reference device and the measuring device based on the comparison.

A subset of antenna components of the measuring device may receive the reference signal, and an angle measurement (or other suitable reference positioning measurement) may be generated from the received reference signal. Since the actual angle measurement (or other suitable reference measurement) is known for a reference signal transmitted by the reference device and received by the measuring device, the measuring device may compare the actual angle measurement to the generated angle measurement to determine a bias associated with the subset of antenna components. In comparison to the real-time measurement method for calibration described above, the actual angle measurement is known instead of relying on a comparison of generated angle measurements for different subsets of antenna components receiving the same reference signal at the same time. As such, a bias between a generated angle measurement and an actual angle measurement may be generated instead of making an assumption as to the bias being the same or different based on a comparison of generated angle measurements. Use of a reference device for calibration does not require receiving the same reference signal at the same time by multiple subsets of antenna components. As such, different subsets of antenna components may receive a reference signal at the same time or at different times.

FIG. 9 shows a flowchart for another exemplary method 900 for identifying one or more AEGs for use by a device to receive one or more reference signals (such as in block 702 of FIG. 7). Method 900 is regarding calibration using a reference device to identify the one or more AEGs. The exemplary method 900 may be performed by any suitable device in a wireless network, such as a UE 104 or base station 102 shown in FIG. 1, in a manner consistent with disclosed implementations. For example, the method 900 may be performed by a UE 104 for DL AoA based UE positioning or by a base station 102 for UL AoA based UE positioning. A device that may perform one or more operations in method 900 may include an antenna system including a plurality of antenna components, at least one transceiver (such as one or more wireless transceivers and/or one or more wired transceivers), at least one memory, and at least one processor coupled to the at least one transceiver and the at least one memory. Referring to the UE 300 as an example device, the antenna system may include antennas 346 and/or other suitable components, the at least one transceiver may include the transceiver 315 or the wireless transceiver 340, the at least one memory may include the memory 311, and the at least one processor may include one or more of the processor 310, one or more of processors 330-334, or the position device 319. Referring to the base station 400 as an example device, the antenna system may include antennas 446 and/or other suitable components, the at least one transceiver may include all or a portion of the transceiver 415, the at least one memory may include the memory 411, and the at least one processor may include the processor 410.

At block 902, the device receives, by the plurality of antenna components, one or more reference signals from a reference device at one or more times. A reference positioning measurement of the reference device is known at the device for each of the one or more reference signals at the one or more times. A reference positioning measurement may be similar to a UE positioning measurement, except that the reference positioning measurement is an actual value instead of an estimated value (such as an actual angle measurement versus an estimated angle measurement). In some implementations, the reference positioning measurement may include an actual angle or another position measurement associated with the reference device and the measuring device. For example, the reference positioning measurement may include one or both of the actual AoA or ZoA of the received reference signal. In some implementations, the reference positioning measurement may be generated based on a known location of the reference device and a known location of the measuring device. For example, the reference device may include one or more identifiers that may be used to determine the location of the reference device with reference to the measuring device (such as one or more of latitude, longitude, or elevation of the reference device). In another example, the reference device may be placed at predefined locations such that the location is known to the measuring device. As such, the reference positioning measurement (such as an actual angle between the reference device and the measuring device) may be known based on the location of the reference device and the location of the measuring device. In an example, when the reference device is in a first location relative to the device, the device may receive a first reference signal from the reference device using a first subset of antenna components. The first location is known or may be obtained by the device (such as from the reference device). For example, the reference device may provide the coordinates of the reference device, or the device may otherwise receive information regarding the location of the reference device. The device may use the first location to determine a first reference positioning measurement associated with the first location. If a second reference signal is to be transmitted, the reference device may remain at the first location or may move to a second location. The device may use the same first subset of antenna components to receive the second reference signal or may use a second subset of antenna components to receive the second reference signal. In some implementations, the device may use multiple subsets of antenna components to receive the same reference signal (such as similar to as described above with reference to real-time measurement based calibration). If a second location is used, a second reference positioning measurement may be generated based on the known second location.

The reference device may continue to move around the measuring device and transmit a reference signal a plurality of times. In this manner, the measuring device receives the reference signal from a plurality of angles and is able to determine the reference positioning measurement associated with each location used by the reference device for transmitting a reference signal. As such, the reference signals received during block 902 may be from a reference device moving around the measuring device and may be associated with one or more reference positioning measurements.

At block 904, for each of a plurality of subsets of antenna components from the plurality of antenna components, the device calculates a device positioning measurement based on a reference signal of the one or more reference signals received at a time of the one or more times by the subset of antenna components. For example, the device may use a first subset of antenna components and/or a second subset of antenna components to receive a first reference signal at a first time from the reference device at a first location. If both subsets of antenna components are used, the device calculates a first device positioning measurement associated with the first subset of antenna components and calculates a second device positioning measurement associated with the second subset of antenna components. For example, the device may calculate an angle measurement for each instance that a reference signal is received by a subset of antenna components.

At block 906, for each of the plurality of subsets of antenna components, the device compares the device positioning measurement to a corresponding reference positioning measurement for the reference signal and the time. As noted above, the reference positioning measurement for a specific reference signal received at a specific time is known (such as an actual angle measurement being determined by the device based on a known location of the reference device and a known location of the device). In comparing the device positioning measurement generated based on the received reference signal to the reference positioning measurement, the difference between elements may indicate the bias associated with subset of antenna components used to receive the reference signal.

At block 908, for each of the plurality of antenna components, the device calculates a bias based on the comparison. For example, a bias may equal the difference between the reference positioning measurement (such as the actual angle measurement) and the device positioning measurement (such as the generated angle measurement).

At block 910, the device groups the subsets of antenna components into the one or more AEGs based on the biases. In some implementations, the biases associated with an AEG are the same. As such, the device may group subsets of antenna components associated with the same bias into an AEG. A “same” bias may refer to two biases being within a tolerance or other predefined range of each other. In some implementations, the biases are associated with the location of the reference device. As such, a subset of antenna components may have a varying bias based on the location of the reference device. Similar to as described above with reference to FIG. 8, an AEG may be associated with a specific location of the reference device or a specific range of locations of the reference device. If an AEG includes multiple subsets of antenna components, all of the antenna components or only a portion of the antenna components may be used to receive a future reference signal, such as described above.

In some implementations, the device (or another suitable device) may store a list of AEGs and their association with specific device positioning measurements or ranges of device positioning measurements. The list may be updated by further iterations of method 900 to identify new or updated AEGs for specific device positioning measurements or ranges of device positioning measurements. During a positioning session, if the device determines that a UE positioning measurement is approximately a first value (such as an angle measurement being a first AoA), the list may be used to look up the first value in the device positioning measurements to identify the associated AEGs that are to be used for receiving future reference signals to generate one or more AEG reports.

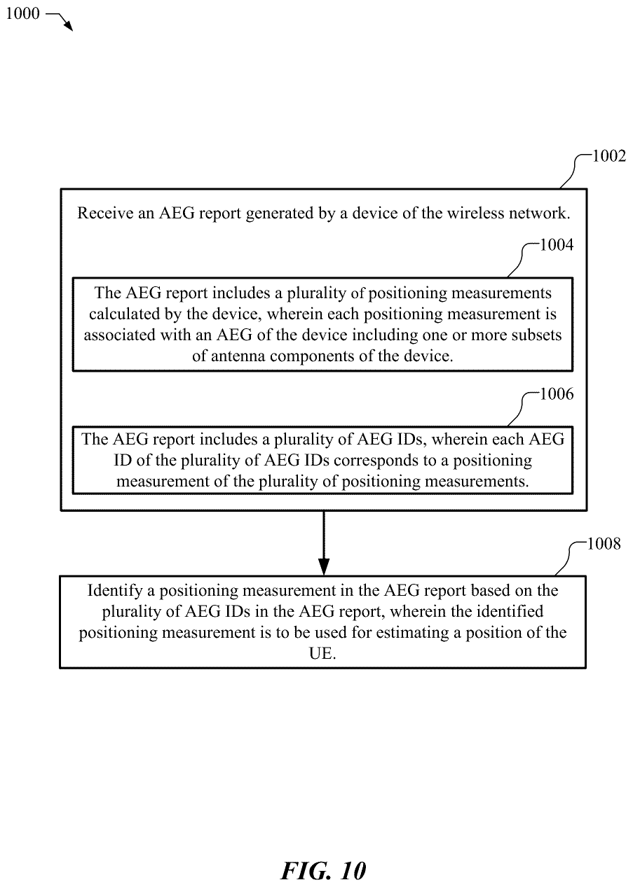

As described above, a base station or a UE may perform a plurality of operations for generating and reporting AEG reports to a location server. The location server may use the AEG reports to perform any number of operations associated with the wireless network. For example, if multiple UE positioning measurements that are associated with different AEG IDs and generated by a base station or UE are reported to the location server, the location server may determine which of the multiple UE positioning measurements is the most accurate or otherwise which of the associated AEGs is the most reliable. With such information, the location server may indicate which AEG is to be used in the future for receiving a reference signal or may determine a location of the UE using the identified positioning measurement (which may be used to determine a configuration of an antenna array for transmit or receive beamforming, for navigation of a UE, for configuring cell selection or handover operation, etc.). Use of the AEG reports is described in more detail below with reference to FIG. 10.

FIG. 10 shows a flowchart for an exemplary method 1000 for using the AEG reports received from one or more devices. The exemplary method 1000 may be performed by any suitable device in a wireless network, such as a location server 172 shown in FIG. 1, in a manner consistent with disclosed implementations. For example, the method 1000 may be performed by a location server 172 for either or both of DL AoA based UE positioning or UL AoA based UE positioning. A device that may perform one or more operations in method 1000 may include at least one transceiver (such as one or more wireless transceivers and/or one or more wired transceivers), at least one memory, and at least one processor coupled to the at least one transceiver and the at least one memory. Referring to the server 500 (e.g., a location server) as an example device, the at least one transceiver may include all or a portion of the transceiver 515, the at least one memory may include the memory 511, and the at least one processor may include the processor 510. A device receiving the AEG reports is referred to as a “location server” in the below description, and the device generating the AEG reports is referred to as a “device” in the below description.

At block 1002, the location server receives an AEG report generated by a device in the wireless network. For example, as described above, a base station or a UE may generate an AEG report and transmit the AEG report in one or more measurement reports to the location server. The AEG report includes a plurality of positioning measurements calculated by the device, and each positioning measurement is associated with an AEG of the device (with the AEG including one or more subsets of antenna components of the device) (1004). In addition, the AEG report includes a plurality of AEG IDs, and each AEG ID of the plurality of AEG IDs corresponds to a positioning measurement of the plurality of positioning measurements (1006). In some implementations, a positioning measurement includes an angle measurement. For example, an AEG report may include a plurality of angle measurements. For an angle measurement, each positioning measurement may include one or more of an AoA of a reference signal received at the device or a ZoA of the reference signal received at the device. Each angle measurement is based on a reference signal received by a subset of antenna components and is associated with a specific AEG. The AEG may be identified by an AEG ID accompanying the UE positioning measurement.

Receiving an AEG report may include receiving a single AEG report or receiving a plurality of AEG reports. In addition, the plurality of positioning measurements may be reported in one main measurement report or in a plurality of measurement reports (such as a main measurement report and one or more secondary measurement reports). In some implementations, at least a portion of the AEG report is included in a main measurement report from the device. In addition or to the alternative, at least a portion of the AEG report is included in one or more secondary measurements reports from the device. For example, a device may generate a plurality of UE positioning measurements from one instance of receiving a reference signal or over time receiving multiple instances of a reference signal. The measurement reports may be generated to include one UE positioning measurement per report, and the location server may receive a measurement report for each UE positioning measurement (with the measurement report also including the associated AEG ID). Alternatively, multiple UE positioning measurements may be received by the location server in one measurement report, and the location server may also receive a plurality of AEG IDs to be used to distinguish between UE positioning measurements.

At block 1008, the location server identifies a positioning measurement in the AEG report based on the plurality of AEG IDs in the AEG report. The identified positioning measurement is to be used for estimating a position of the UE. For example, the positioning measurements received may include angle measurements for a UE at a first position relative to a base station. The plurality of angle measurements may be based on different subsets of antenna components receiving the reference signal used to generate the angle measurements.

To note, the reference signal received by the device to generate one or more positioning measurements is transmitted by a second device. For UL AoA based UE positioning, the device is a base station (such as a gNB), the second device is a UE, and the reference signal is an SRS. For DL AoA based UE positioning, the device is a UE, the second device is a base station (such as a gNB), and the reference signal is a PRS.

In some implementations, the location server is to identify a positioning measurement to be used to calculate a location of the UE in the wireless network. For example, if the plurality of positioning measurements include a plurality of angle measurements, the angle measurements may differ from one another because of different biases associated with the subsets of antenna components used to receive the reference signal for generating the angle measurements. As such, different angle measurements being used to calculate a location of the UE may cause the location to differ. Positioning of the UE may include using the identified positioning measurement as a UE positioning measurement to calculate a location of the UE in the wireless network. As such, the other positioning measurements in the AEG report may be ignored for calculating the location of the UE.

As noted above, the positioning measurements varying for a same actual angle between the device and second device may be based on differing biases associated with the different AEGs. In some implementations, the location server may identify the most accurate positioning measurement from the plurality of the positioning measurements in the AEG report. The “most accurate positioning measurement” may refer to a positioning measurement including the smallest bias. For example, if the positioning measurements include a bias estimation or otherwise a bias may be estimated for each positioning measurement, the location server may select the positioning measurement including the smallest estimated bias. Additionally or alternatively, the “most accurate positioning measurement” may refer to a positioning measurement associated with an acceptable amount of bias. For example, multiple positioning measurements of an AEG report may be considered the “most accurate positioning measurement” if the bias associated with each of the multiple positioning measurements is less than an acceptable threshold of bias. The location server may select one or more positioning measurements with a bias less than the acceptable threshold.

As noted above, if reference device based calibration is performed, a list associating AEGs with angle measurements and biases may be stored at the device. The device may determine biases associated with the positioning measurements generated by the device by looking up a positioning measurement and its associated bias in the list. As such, the device may provide the biases to the location server, and the location server may select the positioning measurement associated with the smallest bias.

In some implementations, a bias is not explicitly indicated or otherwise known to the location server. For example, a device capable of using a reference device for calibration may determine not to provide biases to the location server or may not store a list to keep track of biases. In another example, a device configured for real-time measurement based calibration may be unable to estimate biases. As such, the location server identifying the most accurate positioning measurement may not be a straightforward operation of identifying the positioning measurement having the smallest bias or a plurality of positioning measurements having a bias less than an acceptable threshold.

In some implementations, the location server may use a suitable model constructed based on previous AEG reports to identify a most accurate positioning measurement. An AEG ID may distinguish a subset of antenna components from other subsets of antenna components. For example, a portion of an AEG (such as a defined set of bits of an AEG ID) may be used to uniquely identify a subset of antenna components for the AEG. In some implementations, other portions of the AEG ID may indicate the time the reference signal is received, the reference signal received, the configuration of the subset of antenna components that receives the reference signal, or other information for the AEG. To note, the location server is not required to know the specific subset of antenna components of a device or other information regarding the device. Instead, the location server may use at least a portion of the AEG ID as a label associated with a subset of antenna components or other configuration information regarding the AEG without knowledge of what the AEG IDs stand for.

Positioning measurements from previous AEG reports are also associated with an AEG ID. The AEG IDs may be used to categorize or filter the positioning measurements in order to build the model. For example, the AEG IDs and associated positioning measurements may be used to build a suitable model for the positioning measurements with reference to the AEG IDs (such as a statistical model or a machine learning engine). The location server may also have an indication of, e.g., previous positioning measurements selected by the location server or the most accurate positioning measurement of a previous AEG report (whether or not selected by the location server) that may be used for configuration of the model.

For example, identifying the most accurate positioning measurement may be based on a machine learning engine trained using previous AEG reports associated with the device. The previous AEG reports may be received and stored over time during operation of the device or may be received at one time from the device or another device. The positioning measurements and AEG IDs included in the previous AEG reports may be used as training data for training a machine learning engine. A machine learning engine may include one or more trained machine learning models that are used to identify a most accurate positioning measurement from an input set of positioning measurements from a current AEG report. Example machine learning models may be based, e.g., on one or more of decision trees, random forests, logistic regression, nearest neighbors, classification trees, control flow graphs, support vector machines, naïve Bayes, Bayesian Networks, value sets, hidden Markov models, or neural networks. For example, a decision tree may be trained to classify each positioning measurement as either a most accurate positioning measurement or not. In some implementations, a machine learning model may be configured to generate a probability that a positioning measurement is the most accurate positioning measurement, and the probability may be compared to a threshold. In some other implementations, a machine learning model may be configured to generate an estimated bias associated with a positioning measurement, and the estimated biases may be used to identify the most accurate positioning measurement.

Training a machine learning model may include supervised learning. For supervised learning, the previous AEG reports may be associated with an indication of the one or more positioning measurements of each AEG report that is the most accurate positioning measurement. In some implementations, the previous AEG reports may come from the device. In some other implementations, the previous AEG reports may come from a plurality of devices, which may include the device (such as similar model devices that have the same antenna system configuration). The indication of the most accurate positioning measurements is the desired output data of the machine learning model. The positioning measurements of the AEG reports (and associated AEG IDs) may be provided to the machine learning model, and the machine learning model outputs a decision as to the most accurate positioning measurements. The decision is compared to the desired output, and the machine learning model may be adjusted based on a difference between the decision and the desired output. The process of providing the positioning measurements, receiving a decision, and adjusting the machine learning model may be repeated until the machine learning model is trained. Any suitable training of the machine learning may be performed. For example, the Adam algorithm for optimizing a machine learning model may be used to determine when training of a machine learning model is completed. To note, training of a machine learning model may occur at the location server, or a machine learning model may be trained elsewhere before being provided to the location server for use.

Referring back to block 1008, the identified positioning measurement may also be used by the location server to identify one or more AEGs to be used by the device to receive future reference signals. In some implementations, the location server identifies the AEG ID corresponding to the identified positioning measurement in block 1008. If more than one positioning measurement is identified, the location server may identify the plurality of AEG IDs associated with the plurality of identified positioning measurements. As noted above, the AEG ID may indicate the subset of antenna components for receiving a reference signal, the configuration of the antenna components, the reference signal to be received, and/or the timing of the reference signal to be received for an AEG. With the AEG ID identified, the location server may provide the AEG ID in an indication to the device. For example, the location server may provide a request including one or more AEG IDs indicating the preferred AEGs to be used by the device for receiving a reference signal. In another example, the location server may provide an indication of one or more AEG IDs of AEGs required to be used by the device for receiving a reference signal. As such, the device is to use the AEG associated with the AEG ID in the indication for calculating one or more UE positioning measurements for estimating a position of the UE. In some implementations, the AEG ID may include a portion to indicate the subset of antenna components of the device associated with the AEG and another portion to indicate a reference signal or timing of a reference signal associated with the AEG. The location server may update the portion of the AEG ID to indicate the reference signal to be received or other information as required regarding the reference signal while leaving the remainder of the AEG ID the same. As such, an AEG ID indicated to a device may be used to indicate a future reference signal or future timing of a reference signal. Alternatively, the same AEG ID as received in the AEG report may be provided to the device. The device may use the same AEG ID to identify the subset of antenna components to be used in the future.

As described above, generating an AEG report by a device may be based on a request from a location server for an AEG report. The indication including the one or more AEG IDs identified by the location server may act as a request for a new AEG report from the device. As such, the device may generate an AEG report corresponding to the UE for UE positioning in response to receiving the indication from the location server. The indication to the device may include an indication of time associated with a reference signal to be used in calculating a UE positioning measurement to be included in the AEG report corresponding to the UE. For example, the indication may indicate the time that the reference signal is to be received.

Also as described above, a location server may query a device as to whether the device supports multiple AEGs. Before performing method 1000, a location server may provide a request to the device as to whether the device supports multiple AEGs, and the location server may receive a response from the device indicating that the device supports multiple AEGs. In some implementations, the request also includes a request as to the number of AEGs that the device supports, and the response indicates the number of AEGs supported by the device. If the number of AEGs supported by the device is indicated to the location server, an indication from the location server that includes one or more AEG IDs may be formatted to include a maximum number of AEG IDs equal to the indicated number of AEGs supported by the device.

As described above, a UE, base station, location server, and/or other suitable devices of a wireless network may perform operations to reduce the bias in measurements for UE positioning or to otherwise support operations associated with positioning of a UE. Through use of the above described methods, which antenna components to be used by a device for positioning may be determined in order to increase the accuracy of resulting measurements. Limiting reception to a subset of antenna components of an antenna system may also conserve power or processing resources since all antenna components of the antenna system may not be required (and as such may be placed into a lower power mode than when used). In some implementations, the AEGs to be used may be periodically updated. For example, a location server may periodically perform method 1000 in order to periodically update the AEGs to be used by a base station for UL AoA based UE positioning or by a UE for DL AoA based UE positioning. In another example, a base station or UE may periodically perform method 800 or method 900 to periodically identify new AEGs to be used by the device for receiving a reference signal.

Reference throughout this specification to “one example”, “an example”, “certain examples”, or “exemplary implementation” means that a particular feature, structure, or characteristic described in connection with the feature and/or example may be included in at least one feature and/or example of claimed subject matter. Thus, the appearances of the phrase “in one example”, “an example”, “in certain examples” or “in certain implementations” or other like phrases in various places throughout this specification are not necessarily all referring to the same feature, example, and/or limitation. Furthermore, the particular features, structures, or characteristics may be combined in one or more examples and/or features.

Some portions of the detailed description included herein are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter.

The terms, “and”, “or”, and “and/or” as used herein may include a variety of meanings that also are expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe a plurality or some other combination of features, structures or characteristics. Though, it should be noted that this is merely an illustrative example and claimed subject matter is not limited to this example.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein.

Implementation examples are described in the following numbered clauses:

1. A method for supporting positioning of a user equipment (UE) in a wireless network including:
receiving, by an antenna system of a device, one or more reference signals from a second device, where the antenna system includes a plurality of antenna components;
for one or more subsets of antenna components from the plurality of antenna components, calculating, by a processing system of the device, one or more positioning measurements based on the one or more reference signals from the second device, where:
   each of the one or more subsets of antenna components are associated with a bias in calculating the one or more positioning measurements; and
   each of the one or more subsets of antenna components are included in an angle error group (AEG) of one or more AEGs;
generating, by the processing system, an AEG report, where the AEG report is associated with the one or more positioning measurements calculated by the device; and
reporting the AEG report to another device in the wireless network.

2. The method of clause 1, where a first subset of antenna components associated with a first bias and a second subset of antenna components associated with a second bias are included in a same AEG when the first bias equals the second bias.

3. The method of clause 1, where the antenna system includes:
an antenna array, where the plurality of antenna components includes a plurality of subarrays of the antenna array.

4. The method of clause 1, where the antenna system includes:
a plurality of antennas, where the plurality of antenna components includes the plurality of antennas.

5. The method of clause 1, where the one or more positioning measurements based on the one or more reference signals include one or more of:
an angle of arrival (AoA) of the one or more reference signals at the device; or
a zenith of arrival (ZoA) of the one or more reference signals at the device.

6. The method of clause 5, where the AEG report includes the one or more positioning measurements calculated by the device.

7. The method of clause 6, where each positioning measurement in the AEG report is associated with an AEG identifier (ID), where each AEG ID is associated with an AEG.

8. The method of clause 7, where:
a first positioning measurement calculated based on a first reference signal received at a first time by a first subset of antenna components is associated with a first AEG ID; and
a second positioning measurement calculated based on a second reference signal received at a second time by a second subset of antenna components is associated with a second AEG ID.

9. The method of clause 8, where the first AEG ID differs from the second AEG ID based on one or more of:
the first reference signal differing from the second reference signal;
the first time differing from the second time; or
the first subset of antenna components differing from the second subset of antenna components.

10. The method of clause 7, where the AEG report includes each AEG ID associated with each of the one or more positioning measurements in the AEG report.

11. The method of clause 10, where the AEG report including each AEG ID is based on the AEG report including more than one positioning measurement.

12. The method of clause 7, where the AEG report does not include the AEG ID associated with a positioning measurement when the AEG report includes only one positioning measurement.

13. The method of clause 7, where:
the AEG report includes a plurality of positioning measurements calculated for a plurality of subsets of antenna components of the device; and
the AEG report does not include an AEG ID for each of the plurality of positioning measurements based on the plurality of positioning measurements being the same.

14. The method of clause 7, where the AEG report includes, for each positioning measurement, a timestamp of the reference signal used to calculate the positioning measurement in the AEG report.

15. The method of clause 1, where reporting the AEG report includes transmitting a main measurement report to a location server in the wireless network, where the main measurement report includes at least a portion of the AEG report.

16. The method of clause 1, where reporting the AEG report includes transmitting one or more secondary measurement reports in addition to a main measurement report to a location server in the wireless network, where the one or more secondary measurement reports include at least a portion of the AEG report.

17. The method of clause 1, further including receiving one or more AEG identifiers (IDs) in an indication from a location server of the wireless network, where each AEG ID corresponds to an AEG of the device, where for at least one AEG ID of the one or more AEG IDs:
receiving a reference signal from the second device includes:
   identifying a first subset of antenna components of the AEG corresponding to the AEG ID; and
   receiving the reference signal from the second device using the first subset of antenna components; and
calculating a first positioning measurement based on the reference signal received by the first subset of antenna components, where the AEG report includes the first positioning measurement.

18. The method of clause 17, where each of the AEG IDs in the indication from the location server is required to be used by the device to calculate a positioning measurement.

19. The method of clause 18, where the indication from the location server includes an indication of time associated with a reference signal to be used in calculating a positioning measurement.

20. The method of clause 18, where calculating the positioning measurement for one or more subsets of antenna components is in response to receiving the indication from the location server.

21. The method of clause 1, further including:
receiving a request from a location server as to whether the device supports multiple AEGs; and
providing a response indicating whether the device supports multiple AEGs.

22. The method of clause 21, where:
the request includes a request as to number of AEGs that the device supports; and
the response indicates the number of AEGs supported by the device.

23. The method of clause 1, further including identifying the one or more AEGs, where an AEG of the one or more AEGs includes at least one subset of antenna components from the plurality of antenna components associated with a same bias in calculating positioning measurements.

24. The method of clause 23, where identifying the one or more AEGs includes:
receiving, by the plurality of antenna components, a reference signal from another device at a first time;
for each of a plurality of subsets of antenna components from the plurality of antenna components, calculating a device positioning measurement based on the reference signal received by the subset of antenna components;
comparing the device positioning measurements to one another; and
grouping the subsets of antenna components into the one or more AEGs based on the comparison.

25. The method of clause 24, where the device positioning measurements calculated for the subsets of antenna components of an AEG are the same.

26. The method of clause 23, where identifying the one or more AEGs includes:
receiving, by the plurality of antenna components, one or more reference signals from a reference device at one or more times, where a reference positioning measurement of the reference device is known at the device for each of the one or more reference signals at the one or more times;
for each of a plurality of subsets of antenna components from the plurality of antenna components:
calculating a device positioning measurement based on a reference signal of the one or more reference signals received at a time of the one or more times by the subset of antenna components;
comparing the device positioning measurement to a corresponding reference positioning measurement for the reference signal and the time; and
calculating a bias based on the comparison; and
grouping the subsets of antenna components into the one or more AEGs based on the biases.

27. The method of clause 26, where the biases associated with an AEG are the same.

28. The method of clause 1, where:
the device is a base station;
the second device is the UE; and
the one or more reference signals are one or more sounding reference signals (SRSs).

29. The method of clause 28, where the base station is a gNodeB (gNB).

30. The method of clause 1, where:
the device is the UE;
the second device is a base station; and
the one or more reference signals are one or more positioning reference signals (PRSs).

31. The method of clause 30, where the base station is a gNodeB (gNB).

32. A device configured for supporting positioning of a user equipment (UE) in a wireless network, including:
an antenna system including a plurality of antenna components;
at least one transceiver coupled to the antenna system;
at least one memory; and
at least one processor coupled to the at least one transceiver and the at least one memory, where the at least one processor is configured to:
   receive, via the antenna system and the at least one transceiver, one or more reference signals from a second device;
   for one or more subsets of antenna components from the plurality of antenna components, calculate the one or more positioning measurements based on the one or more reference signals from the second device, where:
      each of the one or more subsets of antenna components are associated with a bias in calculating the one or more positioning measurements; and
      each of the one or more subsets of antenna components are included in an angle error group (AEG) of one or more AEGs;
   generate an AEG report, where the AEG report is associated with the one or more positioning measurements; and
   report, via the at least one transceiver, the AEG report to another device in the wireless network.

33. The device of clause 32, where a first subset of antenna components associated with a first bias and a second subset of antenna components associated with a second bias are included in a same AEG when the first bias equals the second bias.

34. The device of clause 32, where the antenna system includes:
an antenna array, where the plurality of antenna components includes a plurality of subarrays of the antenna array.

35. The device of clause 32, where the antenna system includes:
a plurality of antennas, where the plurality of antenna components includes the plurality of antennas.

36. The device of clause 32, where the one or more positioning measurements include one or more of:
an angle of arrival (AoA) of the one or more reference signals at the device; or
a zenith of arrival (ZoA) of the one or more reference signals at the device.

37. The device of clause 36, where the AEG report includes the one or more positioning measurements.

38. The device of clause 37, where each positioning measurement in the AEG report is associated with an AEG identifier (ID), where each AEG ID is associated with an AEG.

39. The device of clause 38, where:
a first positioning measurement calculated based on a first reference signal received at a first time by a first subset of antenna components is associated with a first AEG ID; and
a second positioning measurement calculated based on a second reference signal received at a second time by a second subset of antenna components is associated with a second AEG ID.

40. The device of clause 39, where the first AEG ID differs from the second AEG ID based on one or more of:
the first reference signal differing from the second reference signal;
the first time differing from the second time; or
the first subset of antenna components differing from the second subset of antenna components.

41. The device of clause 38, where the AEG report includes each AEG ID associated with each of the one or more positioning measurements in the AEG report.

42. The device of clause 41, where the AEG report including each AEG ID is based on the AEG report including more than one positioning measurement.

43. The device of clause 38, where the AEG report does not include the AEG ID associated with a positioning measurement when the AEG report includes only one positioning measurement.

44. The device of clause 38, where:
the AEG report includes a plurality of positioning measurements calculated for a plurality of subsets of antenna components of the device; and
the AEG report does not include an AEG ID for each of the plurality of positioning measurements based on the plurality of positioning measurements being the same.

45. The device of clause 38, where the AEG report includes, for each positioning measurement, a timestamp of the reference signal used to calculate the positioning measurement in the AEG report.

46. The device of clause 32, where, to report the AEG report, the at least one processor is configured to transmit, via the at least one transceiver, a main measurement report to a location server in the wireless network, where the main measurement report includes at least a portion of the AEG report.

47. The device of clause 32, where, to report the AEG report, the at least one processor is configured to transmit, via the at least one transceiver, one or more secondary measurement reports in addition to a main measurement report to a location server in the wireless network, where the one or more secondary measurement reports include at least a portion of the AEG report.

48. The device of clause 32, where the at least one processor is configured to receive, via the antenna system and the at least one transceiver, one or more AEG identifiers (IDs) in an indication from a location server in the wireless network, where each AEG ID corresponds to an AEG of the device, where for at least one AEG ID of the one or more AEG IDs:
to receive a reference signal from the second device, the at least one processor is configured to:
   identify a first subset of antenna components of the AEG corresponding to the AEG ID; and
   receive a reference signal from the second device using
the first subset of antenna components; and
the at least one processor is configured to calculate a first UE positioning measurement based on the reference signal received by the first subset of antenna components, where the AEG report includes the first positioning measurement.

49. The device of clause 48, where each of the AEG IDs in the indication from the location server is required to be used by the device to calculate a positioning measurement.

50. The device of clause 49, where the indication from the location server includes an indication of time associated with a reference signal to be used in calculating a positioning measurement.

51. The device of clause 49, where calculating the positioning measurement for one or more subsets of antenna components is in response to receiving the indication from the location server.

52. The device of clause 32, where the at least one processor is configured to:
receive, via the at least one transceiver, a request from a location server as to whether the device supports multiple AEGs; and
provide, via the at least one transceiver, a response indicating whether the device supports multiple AEGs.

53. The device of clause 52, where:
the request includes a request as to number of AEGs that the device supports; and
the response indicates the number of AEGs supported by the device.

54. The device of clause 32, where the at least one processor is configured to identify the one or more AEGs, where an AEG of the one or more AEGs includes at least one subset of antenna components from the plurality of antenna components associated with a same bias in calculating positioning measurements.

55. The device of clause 54, where, to identify the one or more AEGs, the at least one processor is configured to:
receive, by the plurality of antenna components, a reference signal from another device at a first time;
for each of a plurality of subsets of antenna components from the plurality of antenna components, calculate a device positioning measurement based on the reference signal received by the subset of antenna components;
compare the device positioning measurements to one another; and
group the subsets of antenna components into the one or more AEGs based on the comparison.

56. The device of clause 55, where the device positioning measurements calculated for the subsets of antenna components of an AEG are the same.

57. The device of clause 54, where, to identify the one or more AEGs, the at least one processor is configured to:
receive, by the plurality of antenna components, one or more reference signals from a reference device at one or more times, where a reference positioning measurement of the reference device is known at the device for each of the one or more reference signals at the one or more times;
for each of a plurality of subsets of antenna components from the plurality of antenna components:
   calculate a device positioning measurement based on a reference signal of the one or more reference signals received at a time of the one or more times by the subset of antenna components;
   compare the device positioning measurement to a corresponding reference positioning measurement for the reference signal and the time; and
   calculate a bias based on the comparison; and
group the subsets of antenna components into the one or more AEGs based on the biases.

58. The device of clause 57, where the biases associated with an AEG are the same.

59. The device of clause 32, where:
the device is a base station;
the second device is the UE; and
the one or more reference signals are one or more sounding reference signals (SRSs).

60. The device of clause 59, where the device is a gNodeB (gNB).

61. The device of clause 32, where:
the device is the UE;
the second device is a base station; and
the one or more reference signals are one or more positioning reference signals (PRSs).

62. The device of clause 61, where the base station is a gNodeB (gNB).

63. A method for supporting positioning of a user equipment (UE) in a wireless network including:
receiving an angle error group (AEG) report generated by a device in the wireless network, where the AEG report includes:
   a plurality of positioning measurements calculated by the device, where each positioning measurement is associated with an AEG of the device including one or more subsets of antenna components of the device; and
   a plurality of AEG identifiers (IDs), where each AEG ID of the plurality of AEG IDs corresponds to a positioning measurement of the plurality of positioning measurements; and
identifying a positioning measurement in the AEG report based on the plurality of AEG IDs in the AEG report, where the identified positioning measurement is to be used for estimating a position of the UE.

64. The method of clause 63, where each positioning measurement includes one or more of:
an angle of arrival (AoA) of a reference signal received at the device; or
a zenith of arrival (ZoA) of the reference signal received at the device.

65. The method of clause 64, where:
the reference signal is from a second device; and
estimating a position of the UE includes using the identified positioning measurement to calculate a location of the UE in the wireless network.

66. The method of clause 65, where:
the device is a base station;
the second device is the UE; and
the reference signal is a sounding reference signal (SRS).

67. The method of clause 66, where the device is a gNodeB (gNB).

68. The method of clause 65, where:
the device is the UE;
the second device is a base station; and
the reference signal is a positioning reference signal (PRS).

69. The method of clause 68, where the second device is a gNodeB (gNB).

70. The method of clause 63, where identifying the positioning measurement includes identifying the most accurate positioning measurement from the plurality of positioning measurements in the AEG report.

71. The method of clause 70, where identifying the most accurate positioning measurement is based on a machine learning engine trained using previous AEG reports associated with the device.

72. The method of clause 63, further including:
identifying the AEG ID corresponding to the identified positioning measurement; and
providing the AEG ID in an indication to the device, where the device is to use the AEG associated with the AEG ID in the indication for calculating one or more UE positioning measurements for estimating a position of the UE.

73. The method of clause 72, where an AEG report corresponding to the UE is to be generated by the device in response to receiving the indication.

74. The method of clause 73, where the indication to the device includes an indication of time associated with a reference signal to be used in calculating a positioning measurement to be included in the AEG report corresponding to the UE.

75. The method of clause 63, further including:
providing a request to the device as to whether the device supports multiple AEGs; and
receiving a response from the device indicating that the device supports multiple AEGs.

76. The method of clause 75, where:
the request includes a request as to number of AEGs that the device supports; and
the response indicates the number of AEGs supported by the device.

77. The method of clause 63, where at least a portion of the AEG report is included in a main measurement report from the device.

78. The method of clause 63, where at least a portion of the AEG report is included in one or more secondary measurement reports from the device.

79. A location server configured for supporting positioning of a user equipment (UE) in a wireless network, including:
at least one transceiver;
at least one memory; and
at least one processor coupled to the at least one transceiver and the at least one memory, where the at least one processor is configured to:
   receive, via the at least one transceiver, an angle error group (AEG) report generated by a device in the wireless network, where the AEG report includes:
      a plurality of positioning measurements calculated by the second device, where each positioning measurement is associated with an AEG of the device including one or more subsets of antenna components of the device; and
      a plurality of AEG identifiers (IDs), where each AEG ID of the plurality of AEG IDs corresponds to a positioning measurement of the plurality of positioning measurements; and
   identify a positioning measurement in the AEG report based on the plurality of AEG IDs in the AEG report, where the identified positioning measurement is to be used for estimating a position of the UE.

80. The location server of clause 79, where each positioning measurement includes one or more of:
an angle of arrival (AoA) of a reference signal received at the device; or
a zenith of arrival (ZoA) of the reference signal received at the device.

81. The location server of clause 80, where:
the reference signal is from a second device; and
estimating a position of the UE includes using the identified positioning measurement to calculate a location of the UE in the wireless network.

82. The location server of clause 81, where:
the device is a base station;
the second device is the UE; and
the reference signal is a sounding reference signal (SRS).

83. The location server of clause 82, where the device is a gNodeB (gNB).

84. The location server of clause 81, where:
the device is the UE;
the second device is a base station; and
the reference signal is a positioning reference signal (PRS).

85. The location server of clause 84, where the second device is a gNodeB (gNB).

86. The location server of clause 79, where, to identify the positioning measurement, the at least one processor is configured to identify the most accurate positioning measurement from the plurality of positioning measurements in the AEG report.

87. The location server of clause 86, where identifying the most accurate positioning measurement is based on a machine learning engine trained using previous AEG reports associated with the device.

88. The location server of clause 79, where the at least one processor is configured to:
identify the AEG ID corresponding to the identified positioning measurement; and
provide, via the at least one transceiver, the AEG ID in an indication to the device, where the device is to use the AEG associated with the AEG ID in the indication for calculating one or more positioning measurements for estimating a position of the UE.

89. The location server of clause 88, where an AEG report corresponding to the UE is to be generated by the device in response to receiving the indication.

90. The location server of clause 89, where the indication to the device includes an indication of time associated with a reference signal to be used in calculating a positioning measurement to be included in the AEG report corresponding to the UE.

91. The location server of clause 79, where the at least one processor is configured to:
provide a request to the device as to whether the device supports multiple AEGs; and
receive a response from the device indicating that the device supports multiple AEGs.

92. The location server of clause 91, where:
the request includes a request as to number of AEGs that the device supports; and
the response indicates the number of AEGs supported by the device.

93. The location server of clause 79, where at least a portion of the AEG report is included in a main measurement report from the device.

94. The location server of clause 79, where at least a portion of the AEG report is included in one or more secondary measurement reports from the device.

95. A non-transitory computer-readable medium including instructions that, when executed by at least one processor of a device configured for supporting positioning of a user equipment (UE) in a wireless network, causes the device to perform operations including:
receiving, by an antenna system of a device, one or more reference signals from a second device, where the antenna system includes a plurality of antenna components;
for one or more subsets of antenna components from the plurality of antenna components, calculating, by a processing system of the device, one or more positioning measurements based on the one or more reference signals from the second device, where:
   each of the one or more subsets of antenna components are associated with a bias in calculating the one or more positioning measurements; and
   each of the one or more subsets of antenna components are included in an angle error group (AEG) of one or more AEGs;
generating, by the processing system, an AEG report, where the AEG report is associated with the one or more positioning measurements calculated by the device; and
reporting the AEG report to another device in the wireless network.

96. The computer-readable medium of clause 95, where a first subset of antenna components associated with a first bias and a second subset of antenna components associated with a second bias are included in a same AEG when the first bias equals the second bias.

97. The computer-readable medium of clause 95, where the antenna system includes:
an antenna array, where the plurality of antenna components includes a plurality of subarrays of the antenna array.

98. The computer-readable medium of clause 95, where the antenna system includes:
a plurality of antennas, where the plurality of antenna components includes the plurality of antennas.

99. The computer-readable medium of clause 95, where the one or more positioning measurements based on the one or more reference signals include one or more of:
an angle of arrival (AoA) of the one or more reference signals at the device; or
a zenith of arrival (ZoA) of the one or more reference signals at the device.

100. The computer-readable medium of clause 99, where the AEG report includes the one or more positioning measurements calculated by the device.

101. The computer-readable medium of clause 100, where each positioning measurement in the AEG report is associated with an AEG identifier (ID), where each AEG ID is associated with an AEG.

102. The computer-readable medium of clause 101, where:
a first positioning measurement calculated based on a first reference signal received at a first time by a first subset of antenna components is associated with a first AEG ID; and
a second positioning measurement calculated based on a second reference signal received at a second time by a second subset of antenna components is associated with a second AEG ID.

103. The computer-readable medium of clause 102, where the first AEG ID differs from the second AEG ID based on one or more of:
the first reference signal differing from the second reference signal;
the first time differing from the second time; or
the first subset of antenna components differing from the second subset of antenna components.

104. The computer-readable medium of clause 101, where the AEG report includes each AEG ID associated with each of the one or more positioning measurements in the AEG report.

105. The computer-readable medium of clause 104, where the AEG report including each AEG ID is based on the AEG report including more than one positioning measurement.

106. The computer-readable medium of clause 101, where the AEG report does not include the AEG ID associated with a positioning measurement when the AEG report includes only one positioning measurement.

107. The computer-readable medium of clause 101, where:
the AEG report includes a plurality of positioning measurements calculated for a plurality of subsets of antenna components of the device; and
the AEG report does not include an AEG ID for each of the plurality of positioning requirements based on the plurality of positioning measurements being the same.

108. The computer-readable medium of clause 101, where the AEG report includes, for each positioning measurement, a timestamp of the reference signal used to calculate the positioning measurement in the AEG report.

109. The computer-readable medium of clause 95, where reporting the AEG report includes transmitting a main measurement report to a location server in the wireless network, where the main measurement report includes at least a portion of the AEG report.

110. The computer-readable medium of clause 95, where reporting the AEG report includes transmitting one or more secondary measurement reports in addition to a main measurement report to a location server in the wireless network, where the one or more secondary measurement reports include at least a portion of the AEG report.

111. The computer-readable medium of clause 95, where the operations further include receiving one or more AEG identifiers (IDs) in an indication from a location server of the wireless network, where each AEG ID corresponds to an AEG of the device, where for at least one AEG ID of the one or more AEG IDs:
receiving a reference signal from the second device includes:
   identifying a first subset of antenna components of the AEG corresponding to the AEG ID; and
   receiving the reference signal from the second device
using the first subset of antenna components; and
calculating a first positioning measurement based on the reference signal received by the first subset of antenna components, where the AEG report includes the first positioning measurement.

112. The computer-readable medium of clause 111, where each of the AEG IDs in the indication from the location server is required to be used by the device to calculate a positioning measurement.

113. The computer-readable medium of clause 112, where the indication from the location server includes an indication of time associated with a reference signal to be used in calculating a positioning measurement.

114. The computer-readable medium of clause 112, where calculating the positioning measurement for one or more subsets of antenna components is in response to receiving the indication from the location server.

115. The computer-readable medium of clause 95, where the operations further include:
receiving a request from a location server as to whether the device supports multiple AEGs; and
providing a response indicating whether the device supports multiple AEGs.

116. The computer-readable medium of clause 115, where:
the request includes a request as to number of AEGs that the device supports; and
the response indicates the number of AEGs supported by the device.

117. The computer-readable medium of clause 95, where the operations further include identifying the one or more AEGs, where an AEG of the one or more AEGs includes at least one subset of antenna components from the plurality of antenna components associated with a same bias in calculating positioning measurements.

118. The computer-readable medium of clause 117, where identifying the one or more AEGs includes:
receiving, by the plurality of antenna components, a reference signal from another device at a first time;
for each of a plurality of subsets of antenna components from the plurality of antenna components, calculating a device positioning measurement based on the reference signal received by the subset of antenna components;
comparing the device positioning measurements to one another; and
grouping the subsets of antenna components into the one or more AEGs based on the comparison.

119. The computer-readable medium of clause 118, where the device positioning measurements calculated for the subsets of antenna components of an AEG are the same.

120. The computer-readable medium of clause 117, where identifying the one or more AEGs includes:
receiving, by the plurality of antenna components, one or more reference signals from a reference device at one or more times, where a reference positioning measurement of the reference device is known at the device for each of the one or more reference signals at the one or more times;
for each of a plurality of subsets of antenna components from the plurality of antenna components:
   calculating a device positioning measurement based on a reference signal of the one or more reference signals received at a time of the one or more times by the subset of antenna components;
   comparing the device positioning measurement to a corresponding reference positioning measurement for the reference signal and the time; and
   calculating a bias based on the comparison; and grouping the subsets of antenna components into the one or more AEGs based on the biases.

121. The computer-readable medium of clause 120, where the biases associated with an AEG are the same.

122. The computer-readable medium of clause 95, where:
the device is a base station;
the second device is the UE; and
the one or more reference signals are one or more sounding reference signals (SRSs).

123. The computer-readable medium of clause 122, where the base station is a gNodeB (gNB).

124. The computer-readable medium of clause 95, where:
the device is the UE;
the second device is a base station; and
the one or more reference signals are one or more positioning reference signals (PRSs).

125. The computer-readable medium of clause 124, where the base station is a gNodeB (gNB).

126. A device configured for supporting positioning of a user equipment (UE) in a wireless network, including:
means for receiving one or more reference signals from a second device using an antenna system, where the antenna system includes a plurality of antenna components;
for one or more subsets of antenna components from the plurality of antenna components, means for calculating one or more positioning measurements based on the one or more reference signals from the second device, where:
   each of the one or more subsets of antenna components are associated with a bias in calculating the one or more positioning measurements; and
   each of the one or more subsets of antenna components are included in an angle error group (AEG) of one or more AEGs;
means for generating an AEG report, where the AEG report is associated with the one or more positioning measurements; and
means for reporting the AEG report to another device in the wireless network.

127. The device of clause 126, where a first subset of antenna components associated with a first bias and a second subset of antenna components associated with a second bias are included in a same AEG when the first bias equals the second bias.

128. The device of clause 126, where the antenna system includes:
an antenna array, where the plurality of antenna components includes a plurality of subarrays of the antenna array.

129. The device of clause 126, where the antenna system includes:
a plurality of antennas, where the plurality of antenna components includes the plurality of antennas.

130. The device of clause 126, where the one or more positioning measurements includes one or more of:
an angle of arrival (AoA) of the one or more reference signals at the device; or
a zenith of arrival (ZoA) of the one or more reference signals at the device.

131. The device of clause 130, where the AEG report includes the one or more positioning measurements.

132. The device of clause 131, where each positioning measurement in the AEG report is associated with an AEG identifier (ID), where each AEG ID is associated with an AEG.

133. The device of clause 132, where:
a first positioning measurement calculated based on a first reference signal received at a first time by a first subset of antenna components is associated with a first AEG ID; and
a second positioning measurement calculated based on a second reference signal received at a second time by a second subset of antenna components is associated with a second AEG ID.

134. The device of clause 133, where the first AEG ID differs from the second AEG ID based on one or more of:
the first reference signal differing from the second reference signal;
the first time differing from the second time; or
the first subset of antenna components differing from the second subset of antenna components.

135. The device of clause 132, where the AEG report includes each AEG ID associated with each of the one or more positioning measurements in the AEG report.

136. The device of clause 135, where the AEG report including each AEG ID is based on the AEG report including more than one positioning measurement.

137. The device of clause 132, where the AEG report does not include the AEG ID associated with a positioning measurement when the AEG report includes only one positioning measurement.

138. The device of clause 132, where:
the AEG report includes a plurality of positioning measurements calculated for a plurality of subsets of antenna components of the device; and
the AEG report does not include an AEG ID for each of the plurality of positioning measurements based on the plurality of positioning measurements being the same.

139. The device of clause 132, where the AEG report includes, for each UE positioning measurement, a timestamp of the reference signal used to calculate the positioning measurement in the AEG report.

140. The device of clause 126, where reporting the AEG report includes transmitting a main measurement report to a location server in the wireless network, where the main measurement report includes at least a portion of the AEG report.

141. The device of clause 126, where reporting the AEG report includes transmitting one or more secondary measurement reports in addition to a main measurement report to a location server in the wireless network, where the one or more secondary measurement reports include at least a portion of the AEG report.

142. The device of clause 126, further including means for receiving one or more AEG identifiers (IDs) in an indication from a location server in the wireless network, where each AEG ID corresponds to an AEG of the device, where for at least one AEG ID of the one or more AEG IDs:
receiving a reference signal from the second device includes:
   identifying a first subset of antenna components of the AEG corresponding to the AEG ID; and
   receiving a reference signal from the second device using the first subset of antenna components; and
the device includes means for calculating a first positioning measurement based on the reference signal received by the first subset of antenna components, where the AEG report includes the first positioning measurement.

143. The device of clause 142, where each of the AEG IDs in the indication from the location server is required to be used by the device to calculate a positioning measurement.

144. The device of clause 143, where the indication from the location server includes an indication of time associated with a reference signal to be used in calculating a positioning measurement.

145. The device of clause 143, where calculating the positioning measurement for one or more subsets of antenna components is in response to receiving the indication from the location server.

146. The device of clause 126, further including:
means for receiving a request from a location server as to whether
the device supports multiple AEGs; and
means for providing a response indicating whether the device supports multiple AEGs.

147. The device of clause 146, where:
the request includes a request as to number of AEGs that the device supports; and
the response indicates the number of AEGs supported by the device.

148. The device of clause 126, further including means for identifying the one or more AEGs, where an AEG of the one or more AEGs includes at least one subset of antenna components from the plurality of antenna components associated with a same bias in calculating UE positioning measurements.

149. The device of clause 148, where identifying the one or more AEGs includes:
receiving, by the plurality of antenna components, a reference signal from another device at a first time;
for each of a plurality of subsets of antenna components from the plurality of antenna components, calculating a device positioning measurement based on the reference signal received by the subset of antenna components;
comparing the device positioning measurements to one another; and
grouping the subsets of antenna components into the one or more AEGs based on the comparison.

150. The device of clause 149, where the device positioning measurements calculated for the subsets of antenna components of an AEG are the same.

151. The device of clause 148, where identifying the one or more AEGs includes:
receiving, by the plurality of antenna components, one or more reference signals from a reference device at one or more times, where a reference positioning measurement of the reference device is known at the device for each of the one or more reference signals at the one or more times;
for each of a plurality of subsets of antenna components from the plurality of antenna components:
   calculating a device positioning measurement based on a reference signal of the one or more reference signals received at a time of the one or more times by the subset of antenna components;
   comparing the device positioning measurement to a corresponding reference positioning measurement for the reference signal and the time; and
calculating a bias based on the comparison; and
grouping the subsets of antenna components into the one or more AEGs based on the biases.

152. The device of clause 151, where the biases associated with an AEG are the same.

153. The device of clause 126, where:
the device is a base station;
the second device is the UE; and
the one or more reference signals are one or more sounding reference signals (SRSs).

154. The device of clause 153, where the device is a gNodeB (gNB).

155. The device of clause 126, where:
the device is the UE;
the second device is a base station; and
the one or more reference signals are one or more positioning reference signals (PRSs).

156. The device of clause 155, where the base station is a gNodeB (gNB).

157. A non-transitory computer-readable medium including instructions that, when executed by at least one processor of a location server configured for supporting positioning of a user equipment (UE) in a wireless network, causes the location server to perform operations including:
receiving an angle error group (AEG) report generated by a device in the wireless network, where the AEG report includes:
   a plurality of positioning measurements calculated by the device, where each positioning measurement is associated with an AEG of the device including one or more subsets of antenna components of the device; and
   a plurality of AEG identifiers (IDs), where each AEG ID of the plurality of AEG IDs corresponds to a positioning measurement of the plurality of positioning measurements; and
identifying a positioning measurement in the AEG report based on the plurality of AEG IDs in the AEG report, where the identified positioning measurement is to be used for estimating a position of the UE.

158. The computer-readable medium of clause 157, where each positioning measurement includes one or more of:
an angle of arrival (AoA) of a reference signal received at the device; or
a zenith of arrival (ZoA) of the reference signal received at the device.

159. The computer-readable medium of clause 158, where:
the reference signal is from a second device; and
estimating a positioning of the UE includes using the identified positioning measurement to calculate a location of the UE in the wireless network.

160. The computer-readable medium of clause 159, where:
the device is a base station;
the second device is the UE; and
the reference signal is a sounding reference signal (SRS).

161. The computer-readable medium of clause 160, where the device is a gNodeB (gNB).

162. The computer-readable medium of clause 159, where:
the device is the UE;
the second device is a base station; and
the reference signal is a positioning reference signal (PRS).

163. The computer-readable medium of clause 162, where the second device is a gNodeB (gNB).

164. The computer-readable medium of clause 157, where identifying the positioning measurement includes identifying the most accurate positioning measurement from the plurality of positioning measurements in the AEG report.

165. The computer-readable medium of clause 164, where identifying the most accurate positioning measurement is based on a machine learning engine trained using previous AEG reports associated with the device.

166. The computer-readable medium of clause 157, where the operations further include:
identifying the AEG ID corresponding to the identified positioning measurement; and
providing the AEG ID in an indication to the device, where the device is to use the AEG associated with the AEG ID in the indication for calculating one or more UE positioning measurements for estimating a position of the UE.

167. The computer-readable medium of clause 166, where an AEG report corresponding to the UE is to be generated by the device in response to receiving the indication.

168. The computer-readable medium of clause 167, where the indication to the device includes an indication of time associated with a reference signal to be used in calculating a positioning measurement to be included in the AEG report corresponding to the UE.

169. The computer-readable medium of clause 157, where the operations further include:
providing a request to the device as to whether the device supports multiple AEGs; and
receiving a response from the device indicating that the device supports multiple AEGs.

170. The computer-readable medium of clause 169, where:
the request includes a request as to number of AEGs that the device supports; and
the response indicates the number of AEGs supported by the device.

171. The computer-readable medium of clause 157, where at least a portion of the AEG report is included in a main measurement report from the device.

172. The computer-readable medium of clause 157, where at least a portion of the AEG report is included in one or more secondary measurement reports from the device.

173. A location server configured for supporting positioning of a user equipment (UE) in a wireless network, including:
means for receiving an angle error group (AEG) report generated by a device in the wireless network, where the AEG report includes:
   a plurality of positioning measurements calculated by the second device, where each positioning measurement is associated with an AEG of the device including one or more subsets of antenna components of the device; and
   a plurality of AEG identifiers (IDs), where each AEG ID of the plurality of AEG IDs corresponds to a positioning measurement of the plurality of positioning measurements; and
means for identifying a positioning measurement in the AEG report based on the plurality of AEG IDs in the AEG report, where the identified positioning measurement is to be used for estimating a position of the UE.

174. The location server of clause 173, where each positioning measurement includes one or more of:
an angle of arrival (AoA) of a reference signal received at the device; or
a zenith of arrival (ZoA) of the reference signal received at the device.

175. The location server of clause 174, where:
the reference signal is from a second device; and
estimating a positioning of the UE includes using the identified positioning measurement to calculate a location of the UE in the wireless network.

176. The location server of clause 175, where:
the device is a base station;
the second device is the UE; and
the reference signal is a sounding reference signal (SRS).

177. The location server of clause 176, where the device is a gNodeB (gNB).

178. The location server of clause 175, where:
the device is the UE;
the second device is a base station; and
the reference signal is a positioning reference signal (PRS).

179. The location server of clause 178, where the second device is a gNodeB (gNB).

180. The location server of clause 173, where identifying the positioning measurement includes identifying the most accurate positioning measurement from the plurality of positioning measurements in the AEG report.

181. The location server of clause 180, where identifying the most accurate positioning measurement is based on a machine learning engine trained using previous AEG reports associated with the device.

182. The location server of clause 173, further including:
means for identifying the AEG ID corresponding to the identified positioning measurement; and
means for providing the AEG ID in an indication to the second device, where the device is to use the AEG associated with the AEG ID in the indication for calculating one or more positioning measurements for estimating a position of the UE.

183. The location server of clause 182, where an AEG report corresponding to the UE is to be generated by the device in response to receiving the indication.

184. The location server of clause 183, where the indication to the device includes an indication of time associated with a reference signal to be used in calculating a positioning measurement to be included in the AEG report corresponding to the UE.

185. The location server of clause 173, further including:
means for providing a request to the device as to whether the device supports multiple AEGs; and
means for receiving a response from the device indicating that the device supports multiple AEGs.

186. The location server of clause 185, where:
the request includes a request as to number of AEGs that the device supports; and
the response indicates the number of AEGs supported by the device.

187. The location server of clause 173, where at least a portion of the AEG report is included in a main measurement report from the device.

188. The location server of clause 173, where at least a portion of the AEG report is included in one or more secondary measurement reports from the device.

Therefore, it is intended that claimed subject matter not be limited to the particular examples disclosed, but that such claimed subject matter may also include all aspects falling within the scope of appended claims, and equivalents thereof.

What is claimed is:

1. A method for supporting positioning of a user equipment (UE) in a wireless network comprising:
receiving, by an antenna system of a device, one or more reference signals from a second device, wherein the antenna system includes a plurality of antenna components;
for one or more subsets of antenna components from the plurality of antenna components, calculating, by a processing system of the device, one or more positioning measurements based on the one or more reference signals from the second device, wherein:
each of the one or more subsets of antenna components are associated with a bias in calculating the one or more positioning measurements; and
each of the one or more subsets of antenna components are included in an angle error group (AEG) of one or more AEGs;
generating, by the processing system, an AEG report, wherein the AEG report is associated with the one or more positioning measurements calculated by the device; and
reporting the AEG report to another device in the wireless network.

2. The method of claim 1, wherein a first subset of antenna components associated with a first bias and a second subset of antenna components associated with a second bias are included in a same AEG when the first bias equals the second bias.

3. The method of claim 1, wherein the antenna system includes:
an antenna array, wherein the plurality of antenna components includes a plurality of subarrays of the antenna array.

4. The method of claim 1, wherein the antenna system includes:
a plurality of antennas, wherein the plurality of antenna components includes the plurality of antennas.

5. The method of claim 1, wherein the one or more positioning measurements based on the one or more reference signals include one or more of:
an angle of arrival (AoA) of the one or more reference signals at the device; or
a zenith of arrival (ZoA) of the one or more reference signals at the device.

6. The method of claim 5, wherein the AEG report includes the one or more positioning measurements calculated by the device.

7. The method of claim 6, wherein each positioning measurement in the AEG report is associated with an AEG identifier (ID), wherein each AEG ID is associated with an AEG.

8. The method of claim 7, wherein:
a first positioning measurement calculated based on a first reference signal received at a first time by a first subset of antenna components is associated with a first AEG ID; and
a second positioning measurement calculated based on a second reference signal received at a second time by a second subset of antenna components is associated with a second AEG ID.

9. The method of claim 8, wherein the first AEG ID differs from the second AEG ID based on one or more of:
the first reference signal differing from the second reference signal;
the first time differing from the second time; or
the first subset of antenna components differing from the second subset of antenna components.

10. The method of claim 7, wherein the AEG report includes each AEG ID associated with each of the one or more positioning measurements in the AEG report.

11. The method of claim 10, wherein the AEG report including each AEG ID is based on the AEG report including more than one positioning measurement.

12. The method of claim 7, wherein the AEG report does not include the AEG ID associated with a positioning measurement when the AEG report includes only one positioning measurement.

13. The method of claim 7, wherein:
the AEG report includes a plurality of positioning measurements calculated for a plurality of subsets of antenna components of the device; and
the AEG report does not include an AEG ID for each of the plurality of positioning measurements based on the plurality of positioning measurements being the same.

14. The method of claim 7, wherein the AEG report includes, for each positioning measurement, a timestamp of the reference signal used to calculate the positioning measurement in the AEG report.

15. The method of claim 1, wherein reporting the AEG report includes transmitting a main measurement report to a location server in the wireless network, wherein the main measurement report includes at least a portion of the AEG report.

16. The method of claim 1, wherein reporting the AEG report includes transmitting one or more secondary measurement reports in addition to a main measurement report to a location server in the wireless network, wherein the one or more secondary measurement reports include at least a portion of the AEG report.

17. The method of claim 1, further comprising receiving one or more AEG identifiers (IDs) in an indication from a location server of the wireless network, wherein each AEG ID corresponds to an AEG of the device, wherein for at least one AEG ID of the one or more AEG IDs:
receiving a reference signal from the second device includes:
identifying a first subset of antenna components of the AEG corresponding to the AEG ID; and
receiving the reference signal from the second device using the first subset of antenna components; and
calculating a first positioning measurement based on the reference signal received by the first subset of antenna components, wherein the AEG report includes the first positioning measurement.

18. The method of claim 17, wherein each of the AEG IDs in the indication from the location server is required to be used by the device to calculate a positioning measurement.

19. The method of claim 18, wherein the indication from the location server includes an indication of time associated with a reference signal to be used in calculating a positioning measurement.

20. The method of claim 18, wherein calculating the positioning measurement for one or more subsets of antenna components is in response to receiving the indication from the location server.

21. The method of claim 1, further comprising:
receiving a request from a location server as to whether the device supports multiple AEGs; and
providing a response indicating whether the device supports multiple AEGs.

22. The method of claim 21, wherein:
the request includes a request as to number of AEGs that the device supports; and
the response indicates the number of AEGs supported by the device.

23. The method of claim 1, further comprising identifying the one or more AEGs, wherein an AEG of the one or more AEGs includes at least one subset of antenna components from the plurality of antenna components associated with a same bias in calculating positioning measurements.

24. The method of claim 23, wherein identifying the one or more AEGs includes:
receiving, by the plurality of antenna components, a reference signal from another device at a first time;
for each of a plurality of subsets of antenna components from the plurality of antenna components, calculating a device positioning measurement based on the reference signal received by the subset of antenna components;
comparing the device positioning measurements to one another; and
grouping the subsets of antenna components into the one or more AEGs based on the comparison.

25. The method of claim 24, wherein the device positioning measurements calculated for the subsets of antenna components of an AEG are the same.

26. The method of claim 23, wherein identifying the one or more AEGs includes:
receiving, by the plurality of antenna components, one or more reference signals from a reference device at one or more times, wherein a reference positioning measurement of the reference device is known at the device for each of the one or more reference signals at the one or more times;
for each of a plurality of subsets of antenna components from the plurality of antenna components:
calculating a device positioning measurement based on a reference signal of the one or more reference signals received at a time of the one or more times by the subset of antenna components;
comparing the device positioning measurement to a corresponding reference positioning measurement for the reference signal and the time; and
calculating a bias based on the comparison; and
grouping the subsets of antenna components into the one or more AEGs based on the biases.

27. The method of claim 26, wherein the biases associated with an AEG are the same.

28. The method of claim 1, wherein:
the device is a base station;
the second device is the UE; and
the one or more reference signals are one or more sounding reference signals (SRSs).

29. The method of claim 28, wherein the base station is a gNodeB (gNB).

30. The method of claim 1, wherein:
the device is the UE;
the second device is a base station; and
the one or more reference signals are one or more positioning reference signals (PRSs).

31. The method of claim 30, wherein the base station is a gNodeB (gNB).

32. A device configured for supporting positioning of a user equipment (UE) in a wireless network, comprising:
an antenna system including a plurality of antenna components;
at least one transceiver coupled to the antenna system;
at least one memory; and
at least one processor coupled to the at least one transceiver and the at least one memory, wherein the at least one processor is configured to:
receive, via the antenna system and the at least one transceiver, one or more reference signals from a second device;
for one or more subsets of antenna components from the plurality of antenna components, calculate one or more positioning measurements based on the one or more reference signals from the second device, wherein:
each of the one or more subsets of antenna components are associated with a bias in calculating the one or more positioning measurements; and
each of the one or more subsets of antenna components are included in an angle error group (AEG) of one or more AEGs;
generate an AEG report, wherein the AEG report is associated with the one or more positioning measurements; and
report, via the at least one transceiver, the AEG report to another device in the wireless network.

33. The device of claim 32, wherein a first subset of antenna components associated with a first bias and a second subset of antenna components associated with a second bias are included in a same AEG when the first bias equals the second bias.

34. The device of claim 32, wherein the antenna system includes:
an antenna array, wherein the plurality of antenna components includes a plurality of subarrays of the antenna array.

35. The device of claim 32, wherein the antenna system includes:
a plurality of antennas, wherein the plurality of antenna components includes the plurality of antennas.

36. The device of claim 32, wherein the one or more positioning measurements include one or more of:
an angle of arrival (AoA) of the one or more reference signals at the device; or
a zenith of arrival (ZoA) of the one or more reference signals at the device.

37. The device of claim 36, wherein the AEG report includes the one or more positioning measurements.

38. The device of claim 37, wherein each positioning measurement in the AEG report is associated with an AEG identifier (ID), wherein each AEG ID is associated with an AEG.

39. The device of claim 38, wherein:
a first positioning measurement calculated based on a first reference signal received at a first time by a first subset of antenna components is associated with a first AEG ID; and
a second positioning measurement calculated based on a second reference signal received at a second time by a second subset of antenna components is associated with a second AEG ID.

40. The device of claim 39, wherein the first AEG ID differs from the second AEG ID based on one or more of:
the first reference signal differing from the second reference signal;
the first time differing from the second time; or
the first subset of antenna components differing from the second subset of antenna components.

41. The device of claim 38, wherein the AEG report includes each AEG ID associated with each of the one or more positioning measurements in the AEG report.

42. The device of claim 41, wherein the AEG report including each AEG ID is based on the AEG report including more than one positioning measurement.

43. The device of claim 38, wherein the AEG report does not include the AEG ID associated with a positioning measurement when the AEG report includes only one positioning measurement.

44. The device of claim 38, wherein:
the AEG report includes a plurality of positioning measurements calculated for a plurality of subsets of antenna components of the device; and
the AEG report does not include an AEG ID for each of the plurality of positioning measurements based on the plurality of positioning measurements being the same.

45. The device of claim 38, wherein the AEG report includes, for each positioning measurement, a timestamp of the reference signal used to calculate the positioning measurement in the AEG report.

46. The device of claim 32, wherein, to report the AEG report, the at least one processor is configured to transmit, via the at least one transceiver, a main measurement report to a location server in the wireless network, wherein the main measurement report includes at least a portion of the AEG report.

47. The device of claim 32, wherein, to report the AEG report, the at least one processor is configured to transmit, via the at least one transceiver, one or more secondary measurement reports in addition to a main measurement report to a location server in the wireless network, wherein the one or more secondary measurement reports include at least a portion of the AEG report.

48. The device of claim 32, wherein the at least one processor is configured to receive, via the antenna system and the at least one transceiver, one or more AEG identifiers (IDs) in an indication from a location server in the wireless network, wherein each AEG ID corresponds to an AEG of the device, wherein for at least one AEG ID of the one or more AEG IDs:
to receive a reference signal from the second device, the at least one processor is configured to:
identify a first subset of antenna components of the AEG corresponding to the AEG ID; and
receive a reference signal from the second device using the first subset of antenna components; and
the at least one processor is configured to calculate a first positioning measurement based on the reference signal received by the first subset of antenna components, wherein the AEG report includes the first positioning measurement.

49. The device of claim 48, wherein each of the AEG IDs in the indication from the location server is required to be used by the device to calculate a positioning measurement.

50. The device of claim 49, wherein the indication from the location server includes an indication of time associated with a reference signal to be used in calculating a positioning measurement.

51. The device of claim 49, wherein calculating the positioning measurement for one or more subsets of antenna components is in response to receiving the indication from the location server.

52. The device of claim 32, wherein the at least one processor is configured to:
receive, via the at least one transceiver, a request from a location server as to whether the device supports multiple AEGs; and
provide, via the at least one transceiver, a response indicating whether the device supports multiple AEGs.

53. The device of claim 52, wherein:
the request includes a request as to number of AEGs that the device supports; and
the response indicates the number of AEGs supported by the device.

54. The device of claim 32, wherein the at least one processor is configured to identify the one or more AEGs, wherein an AEG of the one or more AEGs includes at least one subset of antenna components from the plurality of antenna components associated with a same bias in calculating positioning measurements.

55. The device of claim 54, wherein, to identify the one or more AEGs, the at least one processor is configured to:
receive, by the plurality of antenna components, a reference signal from another device at a first time;
for each of a plurality of subsets of antenna components from the plurality of antenna components, calculate a device positioning measurement based on the reference signal received by the subset of antenna components;
compare the device positioning measurements to one another; and
group the subsets of antenna components into the one or more AEGs based on the comparison.

56. The device of claim 55, wherein the device positioning measurements calculated for the subsets of antenna components of an AEG are the same.

57. The device of claim 54, wherein, to identify the one or more AEGs, the at least one processor is configured to:
receive, by the plurality of antenna components, one or more reference signals from a reference device at one or more times, wherein a reference positioning measurement of the reference device is known at the device for each of the one or more reference signals at the one or more times;
for each of a plurality of subsets of antenna components from the plurality of antenna components:
calculate a device positioning measurement based on a reference signal of the one or more reference signals received at a time of the one or more times by the subset of antenna components;
compare the device positioning measurement to a corresponding reference positioning measurement for the reference signal and the time; and
calculate a bias based on the comparison; and
group the subsets of antenna components into the one or more AEGs based on the biases.

58. The device of claim 57, wherein the biases associated with an AEG are the same.

59. The device of claim 32, wherein:
the device is a base station;
the second device is the UE; and
the one or more reference signals are one or more sounding reference signals (SRSs).

60. The device of claim 59, wherein the device is a gNodeB (gNB).

61. The device of claim 32, wherein:
the device is the UE;
the second device is a base station; and
the one or more reference signals are one or more positioning reference signals (PRSs).

62. The device of claim 61, wherein the base station is a gNodeB (gNB).

63. A method for supporting positioning of a user equipment (UE) in a wireless network comprising:
receiving an angle error group (AEG) report generated by a device in the wireless network, wherein the AEG report includes:
a plurality of positioning measurements calculated by the device, wherein each positioning measurement is associated with an AEG of the device including one or more subsets of antenna components of the device; and
a plurality of AEG identifiers (IDs), wherein each AEG ID of the plurality of AEG IDs corresponds to a positioning measurement of the plurality of positioning measurements; and
identifying a positioning measurement in the AEG report based on the plurality of AEG IDs in the AEG report, wherein the identified positioning measurement is to be used for estimating a position of the UE.

64. The method of claim 63, wherein each positioning measurement includes one or more of:
an angle of arrival (AoA) of a reference signal received at the device; or
a zenith of arrival (ZoA) of the reference signal received at the device.

65. The method of claim 64, wherein:
the reference signal is from a second device; and
estimating a position of the UE includes using the identified positioning measurement to calculate a location of the UE in the wireless network.

66. The method of claim 65, wherein:
the device is a base station;
the second device is the UE; and
the reference signal is a sounding reference signal (SRS).

67. The method of claim 66, wherein the device is a gNodeB (gNB).

68. The method of claim 65, wherein:
the device is the UE;
the second device is a base station; and
the reference signal is a positioning reference signal (PRS).

69. The method of claim 68, wherein the second device is a gNodeB (gNB).

70. The method of claim 63, wherein identifying the positioning measurement includes identifying the most accurate positioning measurement from the plurality of positioning measurements in the AEG report.

71. The method of claim 70, wherein identifying the most accurate positioning measurement is based on a machine learning engine trained using previous AEG reports associated with the device.

72. The method of claim 63, further comprising:
identifying the AEG ID corresponding to the identified positioning measurement; and
providing the AEG ID in an indication to the device, wherein the device is to use the AEG associated with the AEG ID in the indication for calculating one or more positioning measurements for estimating a position of the UE.

73. The method of claim 72, wherein an AEG report corresponding to the UE is to be generated by the device in response to receiving the indication.

74. The method of claim 73, wherein the indication to the device includes an indication of time associated with a reference signal to be used in calculating a positioning measurement to be included in the AEG report corresponding to the UE.

75. The method of claim 63, further comprising:
providing a request to the device as to whether the device supports multiple AEGs; and
receiving a response from the device indicating that the device supports multiple AEGs.

76. The method of claim 75, wherein:
the request includes a request as to number of AEGs that the device supports; and
the response indicates the number of AEGs supported by the device.

77. The method of claim 63, wherein at least a portion of the AEG report is included in a main measurement report from the device.

78. The method of claim 63, wherein at least a portion of the AEG report is included in one or more secondary measurement reports from the device.

79. A location server configured for supporting positioning of a user equipment (UE) in a wireless network, comprising:
at least one transceiver;
at least one memory; and
at least one processor coupled to the at least one transceiver and the at least one memory, wherein the at least one processor is configured to:
receive, via the at least one transceiver, an angle error group (AEG) report generated by a device in the wireless network, wherein the AEG report includes:
a plurality of positioning measurements calculated by the device, wherein each positioning measurement is associated with an AEG of the device including one or more subsets of antenna components of the device; and
a plurality of AEG identifiers (IDs), wherein each AEG ID of the plurality of AEG IDs corresponds to a positioning measurement of the plurality of positioning measurements; and
identify a positioning measurement in the AEG report based on the plurality of AEG IDs in the AEG report, wherein the identified positioning measurement is to be used for estimating a position of the UE.

80. The location server of claim 79, wherein each positioning measurement includes one or more of:
an angle of arrival (AoA) of a reference signal received at the device; or
a zenith of arrival (ZoA) of the reference signal received at the device.

81. The location server of claim 80, wherein:
the reference signal is from a second device; and
estimating a position of the UE includes using the identified positioning measurement to calculate a location of the UE in the wireless network.

82. The location server of claim 81, wherein:
the device is a base station;
the second device is the UE; and
the reference signal is a sounding reference signal (SRS).

83. The location server of claim 82, wherein the device is a gNodeB (gNB).

84. The location server of claim 81, wherein:
the device is the UE;
the second device is a base station; and
the reference signal is a positioning reference signal (PRS).

85. The location server of claim 84, wherein the second device is a gNodeB (gNB).

86. The location server of claim 79, wherein, to identify the positioning measurement, the at least one processor is configured to identify the most accurate positioning measurement from the plurality of positioning measurements in the AEG report.

87. The location server of claim 86, wherein identifying the most accurate positioning measurement is based on a machine learning engine trained using previous AEG reports associated with the device.

88. The location server of claim 79, wherein the at least one processor is configured to:
identify the AEG ID corresponding to the identified positioning measurement; and
provide, via the at least one transceiver, the AEG ID in an indication to the device, wherein the device is to use the AEG associated with the AEG ID in the indication for calculating one or more positioning measurements for estimating a position of the UE.

89. The location server of claim 88, wherein an AEG report corresponding to the UE is to be generated by the device in response to receiving the indication.

90. The location server of claim 89, wherein the indication to the device includes an indication of time associated with a reference signal to be used in calculating a positioning measurement to be included in the AEG report corresponding to the UE.

91. The location server of claim 79, wherein the at least one processor is configured to:
provide a request to the device as to whether the device supports multiple AEGs; and
receive a response from the device indicating that the device supports multiple AEGs.

92. The location server of claim 91, wherein:
the request includes a request as to number of AEGs that the device supports; and
the response indicates the number of AEGs supported by the device.

93. The location server of claim 79, wherein at least a portion of the AEG report is included in a main measurement report from the device.

94. The location server of claim 79, wherein at least a portion of the AEG report is included in one or more secondary measurement reports from the device.
